(19) United States
(12) Patent Application Publication
(10) Pub. No.: US 2005/0208324 A1
(43) Pub. Date: Sep. 22, 2005

(54) Manesium base alloy tube and method for manufacture thereof

(76) Inventors: Yukihiro Oishi, Itami-shi (JP); Nozomu Kawabe, Itami-shi (JP); Hitoshi Takahashi, Itami-shi (JP); Katsumi Wakamatsu, Itami-shi (JP)

Correspondence Address: MCDERMOTT WILL & EMERY LLP, 600 13TH STREET, N.W., WASHINGTON, DC, 20005-3096, US

(21) Appl. No.: 10/506,509

(22) PCT Filed: Mar. 4, 2003
(86) PCT No.: PCT/JP03/02524

§ 371 Date: Sep. 3, 2004

(30) Foreign Application Priority Data
Mar. 4, 2002 (JP) 2002-57861
Mar. 4, 2002 (JP) 2002-57870
Mar. 7, 2002 (JP) 2002-62367
Mar. 7, 2002 (JP) 2002-62432
Mar. 25, 2002 (JP) 2002-83131
Feb. 12, 2002 (JP) 2002-350061
Mar. 3, 2003 (JP) 2003-55502

(51) Int. Cl. B32B 15/10

(52) U.S. Cl. 428/654; 428/658

(57) ABSTRACT

A magnesium base alloy pipe having high strength and toughness is provided along with a method of manufacturing such pipes. A magnesium base alloy pipe, wherein the pipe is produced by drawing a pipe blank of a magnesium base alloy comprising containing either of the following ingredients (1) or (2): (1) about 0.1-12.0 mass % of Al; or (2) about 1.0-10.0 mass % of Zn and about 0.1-2.0 mass % of Zr. The novel alloy pipe is manufactured by a method comprising steps of providing the above-described pipe blank, pointing the pipe blank, and drawing the pointed pipe blank. The drawing step is executed at a drawing temperature above approx. 50 ° C.

### BACKGROUND OF THE INVENTION

1. Technical Field

The present invention relates to a magnesium base alloy pipes or tubes and a method of manufacturing the same. More specifically, the present invention relates to a magnesium base alloy pipes or tubes having improved toughness or high strength and to a method of manufacturing such pipes.

2. Background Art

Magnesium base alloys, lighter than aluminum and superior to steel and aluminum in specific strength and specific rigidity, are extensively used for aircraft parts, automobile parts, etc. as well as bodies of various electric appliances, or for many other applications. Particularly, magnesium base alloys have been used heretofore for press moldings or press-molded products, and as a method for manufacturing sheet materials for press molding a rolling process has been typically known (for example, see Patent Document 1 and Patent Document 2).

Here, Patent Document 1 is Japanese Patent Provisional Publication No. 2001-200349, and Patent Document 2 is Japanese Patent Provisional Publication No. H06-293944.

For the magnesium base alloys having excellent properties as described above, it is desired that they are used not only as sheet materials but as pipes or tubular materials.

However, since magnesium and its alloys have a close-packed hexagonal lattice structure, they lacks in ductility with their marked inferiority in plastic workability. Therefore, it has been very difficult so far to produce pipes of magnesium or its alloys.

Although magnesium base alloy pipes may be hot-extruded into pipes, the resultant pipes have been hardly used for structural materials because of their very low strength. For example, such hot-extruded pipes of magnesium alloy are not in the least superior to pipes of aluminum alloy in strength.

Accordingly, it is a principal object of the present invention to provide magnesium base alloy pipes or tubes having high strength or improved toughness or tenacity and a method of manufacturing such pipes.

Further, another object of the present invention is to provide magnesium base alloy pipes having a high YP ratio (a ratio of 0.2% proof stress vs. tensile strength, to be described herein later) and method of manufacturing such pipes.

### DISCLOSURE OF INVENTION

The inventors have studied from various aspects the drawing technique of magnesium base alloys that had been deemed till then difficult in the art to find out that drawn magnesium base alloy pipes can be improved in their strength and ductility by using specified processing conditions in drawing, and have accomplished the present invention based on those findings.

Further, the inventors have found out that a drawing process, when combined as required with a prescribed heat treatment as a process subsequent to the drawing, is effective for producing magnesium base alloy pipes that can compatibly satisfy both a high YP ratio and a high ductility at high strength, and based on such findings have accomplished the present invention.

(Magnesium Base Alloy Pipes)

Specifically, in one aspect, the present invention provides a magnesium base alloy pipe, wherein the pipe is produced by drawing a pipe blank of a magnesium base alloy containing either of the following chemical ingredients (1) or (2):
(1) about 0.1-12.0 mass % of Al;
(2) about 1.0-10.0 mass % of Zn and about 0.1-2.0 mass % of Zr.

For magnesium base alloy pipes of the present invention, both casting magnesium base alloys and wrought magnesium base alloys may be used alike. More specifically, magnesium base alloys belonging to AZ, AS, AM, or ZK types in the ASTM Code may be used, for example. Also, the magnesium base alloys may be subdivided in terms of Al content into two groups, namely magnesium base alloys containing 0.1 to less than 2.0 mass % of Al, and those containing 2.0 to 12.0 mass % of Al. Besides the above-mentioned chemical ingredients, the magnesium base alloys, as practically used, contain unavoidable impurities in addition to their main ingredient Mg, as is known to those who skilled in the art. The unavoidable impurities include Fe, Si, Cu, Ni, Ca, etc.

In the ASTM AZ type, alloys subject to AZ31, AZ61, AZ91, for example, have an Al content in the range of 2.0-12.0% by mass. The AZ31 represents, for example, magnesium base alloys containing 2.5-3.5 mass % of Al, 0.5-1.5 mass % of Zn, 0.15-0.5 mass % of Mn, 0.05 or less mass % of Cu, 0.1 or less mass % of Si, and 0.04 or less mass % of Ca. The AZ61 represents, for example, magnesium base alloys containing 5.5-7.2 mass % of Al, 0.4-1.5 mass % of Zn, 0.15-0.35 mass % of Mn, 0.05 or less mass % of Ni, and 0.1 or less mass % of Si. The AZ91 represents, for example, magnesium base alloys containing 8.1-9.7 mass % of Al, 0.35-1.0 mass % of Zn, 0.13 or more mass % of Mn, 0.1 or less mass % of Cu, 0.03 or less mass % of Ni, and 0.5 or less mass % of Si. The magnesium base alloys of the ASTM AZ type containing about 0.1 to less than-2.0 mass % of Al are represented by AZ10 and AZ21, for example. The AZ10 represents, for example, magnesium base alloys containing 1.0-1.5 mass % of Al, 0.2-0.6 mass % of Zn, 0.2 or more mass % of Mn, 0.1 or less mass % of Cu, 0.1 or less mass % of Si, and 0.4 or less mass % of Ca. The AZ21 represents, for example, magnesium base alloys containing 1.4-2.6 mass % of Al, 0.5-1.5 mass % of Zn, 0.15-0.35 mass % of Mn, 0.03 or less mass % of Ni, and 0.1 or less mass % of Si.

The magnesium base alloys of the ASTM AS type containing 2.0-12.0 mass % of Al are represented by AS41, for example. The AS41 represents, for example, magnesium base alloys containing 3.7-4.8 mass % of Al, 0.1 or less mass % of Zn, 0.15 or less mass % of Cu, 0.35-0.60 mass % of Mn, 0.001 or less mass % of Ni, and 0.6-1.4 mass % of Si. In the ASTM AS type, alloys subject to AS21, for example, have an Al content in the range of 0.1 to less than 2.0% by mass. The AS21 represents, for example, magnesium base alloys containing 1.4-2.6 mass % of Al, 0.1 or less mass % of Zn, 0.15 or less mass % of Cu, 0.35-0.60 mass % of Mn, 0.0 4 01 or less mass % of Ni, and 0.6-1.4 mass % of Si.

In the ASTM AM type, the AM60 represents, for example, magnesium base alloys containing 5.5-6.5 mass % of Al, 0.22 or less mass % of Zn, 0.35 or less mass % of Cu, 0.13 or more mass % of Mn, 0.03 or less mass % of Ni, and 0.5 or less mass % of Si. The AM100 represents, for example, magnesium base alloys containing 9.3-10.7 mass % of Al, 0.3 or less mass % of Zn, 0.1 or less than % of Cu, 0.1-0.35 mass % of Mn, 0.01 or less mass % of Ni, and 0.3 or less mass % of Si.

In the ASTM ZK type, the ZK60 represents, for example, magnesium base alloys containing about 4.8-6.2 mass % of Zn, and 0.45 or more mass % of Zr.

Although magnesium can hardly provide any sufficient strength when used as a simple substance material, its alloy containing either 0.1-2.0 mass % of Al or 1.0-10.0 mass % of Zn and 0.1-2.0 mass % of Zr, as described above, and processed through a prescribed drawing can have desirable strength. It is preferred that the magnesium base alloys containing about 0.1-12.0 mass % of Al for the pipe according to the present invention contain about 0.1-2.0 mass % of Mn. Also, the magnesium base alloys containing about 0.1-12.0 mass % of Al for the pipe according to the present invention may preferably contain at least one of about 0.1-5.0 mass % of Zn and 0.1-5.0 mass % of Si. In this regard, a more preferable Zn content ranges from about 0.1 to 2.0 mass % and a more preferable Si content ranges from 0.3 to 2.0 mass %. Drawing under conditions described later a magnesium base alloy containing the above-described elements as additives can yield a magnesium base alloy pipe having not only mechanical strength but also toughness. A more preferable Zr content is about 0.4-2.0% by mass.

Moreover, since the magnesium base alloy pipes of the present invention combine high strength and outstanding toughness such as a 3% or higher elongation (elongation after fracture) and 250 MPa or higher tensile strength, they exhibit higher specific strength as compared with like materials in the prior art and thus may be applicable to structural materials for lightweight-oriented fields where such strength is particularly required. The magnesium base alloy pipes according to the present invention, thus having such high strength and toughness, can advantageously secure safety when used as such structural materials.

According to the present invention, preferable minimum tensile strength varies among 250, 280, 300, 320 and 350 MPa or higher. Magnesium base alloy pipes having 350 MPa or higher tensile strength with an 3% or larger elongation have larger specific strength as compared with the conventional materials and may most preferably used for structural materials in lightweight-oriented applications where the strength matters particularly. Of course, it goes without saying that magnesium base alloy pipes with tensile strength 350 MPa or less may also be practically used in various applications. A more preferable elongation is 8% or above and, particularly preferably, 15% or above. Especially, magnesium base alloy pipes having 250-350 MPa tensile strength with a 15-20% elongation exhibit excellent toughness, and can be subjected to bending at small radii and thus are expectedly applicable to diverse structural materials. More specifically, if such magnesium -base alloy pipes have an outside diameter of D (mm), they can be bent easily at a bending radius 3D or less. Also, according to the present invention, the magnesium base alloy pipes may be subdivided in terms of elongation into two groups, namely pipes having an elongation of not less than 5% but less than 12% and pipes having a 12% or higher elongation. Typically, magnesium base alloys with a 20% or lower elongation may be practically used.

In another aspect, the present invention provides a magnesium base alloy pipe having chemical compositions as described herein above, wherein the pipe has a YP ratio not less than 0.75.

The YP ratio herein referred to is a ratio given by “0.2% proof stress/tensile strength.” For applying a magnesium base alloy to a structural material, high strength is desired. In this connection, since the working limit is determined not based on tensile strength but on 0.2% proof stress, it is necessary to increase not only the absolute tensile strength but also YP ratio for providing high-strength magnesium base alloy. Magnesium base alloy pipes obtained by the conventional hot extrusion technique have a YP ratio in the range of 0.5 or more but less than 0.75, which is not in the least high as compared with ordinary structural materials, and thus it has been demanded to increase the YP ratio of such pipes. Accordingly, the present invention provides a magnesium base alloy pipe having a 0.75 or higher YP ratio that has not been achieved in the prior art by using specified processing conditions in drawing operation including drawing temperature, working ratio or reduction ratio, heating rate to the drawing temperature and drawing speed, and as required by applying a prescribed heat treatment after drawing, as described herein below.

For example, a magnesium base alloy pipe with a 0.90 or higher YP ratio can be obtained by performing drawing at a 1 m/sec. or higher drawing speed at a drawing temperature ranging from about 50° C. to 300° C. (more preferably from 100° C. to 200° C., still more preferably from 100° C. to 150° C. ) with a heating rate to drawing temperature of 1° C./sec.-100° C./sec. and a working ratio above 5% per one drawing pass (more preferably above 10% or more, particularly preferably above 20%. Further, a magnesium base alloy pipe having a YP ratio in the range of 0.75 or more but less than 0.90 can be produced by providing a cooling step after the aforesaid drawing step and then subjecting the pipe to a heat treatment at a temperature ranging from 150° C. (preferably 200° C.) to 300° C. over a retention time of Smin or longer. Although a higher YP ratio typically represents higher strength, since such a high YP ratio naturally leads to a lower workability when some postprocessing such as bending is involved, magnesium base alloy pipes having a YP ratio in the range of 0.75 or more but less than 0.90 are favorably practical in view of manufacturability or productivity. According to the present invention, a more preferable YP ratio ranges from 0.80 or more but less than 0.90.

In its third aspect, the present invention provides a magnesium base alloy pipe having the above-described chemical composition, wherein the pipe has 0.2% proof stress not less than 220 MPa.

The working limit of a structural material is determined depending on its 0.2% proof stress, as described above. Accordingly, the present invention provides a magnesium base alloy pipe having higher specific proof stress as compared with the conventional materials, specifically 0.2% proof stress not less than 220 MPa, by using specified processing conditions in drawing operation including drawing temperature, working ratio or reduction ratio, heating rate to the drawing temperature and drawing speed. More preferably, the 0.2% proof stress is not less than 250 MPa.

In its fourth aspect, the present invention provides a magnesium base alloy pipe having the above-described chemical composition, wherein its magnesium base alloy has an average grain size of 10 μm (micrometers) or below.

A magnesium base alloy pipe having both strength and toughness in balance can be produced by making fine the average grain size of its magnesium base alloy. The control of average grain size is effected by adjusting processing conditions in drawing operation such as working ratio, drawing temperature, or heat treatment temperature after drawing. For reducing the average grain size to 10 μm or smaller, it is preferable to heat-treat the pipe at 200° C. or higher temperatures after drawing.

Especially, by providing a fine crystal structure with an average grain size of 5 μm or below, a magnesium base alloy pipe satisfying its strength and toughness requirements further in balance. Such a fine crystal structure having an average grain size of 5 μm or below may be obtained by applying a heat treatment at a temperature preferably in the range of 200° C. to 250° C. after drawing.

In its fifth aspect, the present invention provides a magnesium base alloy pipe having the above-described chemical composition, wherein its magnesium base alloy has a mixed or duplex grain structure comprising fine grains and coarse grains.

By providing the alloy with a duplex grain structure, a magnesium base alloy pipe combining strength with toughness in balance can be obtained. As an example, one typical duplex grain structure in such a magnesium base alloy comprises fine grains with an average grain size of 3 μm or below and coarse grains having an average grain size not smaller than 15 μm. Especially, by controlling to a 10% or grater level the ratio of the total area shared by 3 μm or smaller grains in any section of an alloy sample (hereinafter shall be briefly referred to as “grains area share”), a magnesium base alloy pipe having further improved strength and toughness can be attained. Such a duplex grain structure can be created by a combination of a drawing process with a heat treatment subsequent thereto, as will be described herein later. For this, the heat treatment is performed preferably at 150° C. or above but below 200° C.

In its sixth aspect, the present invention provides a magnesium base alloy pipe having the above-described chemical composition, wherein its alloy has a mixed or hybrid structure comprising twins and recrystallized grains.

By providing such a mixed structure, a magnesium base alloy pipe can have improved strength and toughness in balance.

In its seventh aspect, the present invention provides a magnesium base alloy pipe having the above-described chemical composition, wherein the surface roughness Rz of its alloy satisfies a condition given by: Rz≦5 μm.

In its eighth aspect, the present invention provides a magnesium base alloy pipe having the above-described chemical composition, wherein the pipe has in its surface an axial residual tensile stress not greater than 80 MPa.

In its ninth aspect, the present invention provides a magnesium base alloy pipe having the above-described chemical composition, wherein the pipe has a 0.02 mm or smaller differential outside diameter. The “differential outside diameter” herein referred to is the difference between the largest and the smallest outside diameters in a cross section of the pipe.

For a magnesium base alloy pipe, a surface smoothness, an axial residual tensile stress below a predetermined value or a differential outside diameter below a predetermined value leads to an excellent precision workability in that such factors are effective for improving accuracy in bending and the like processes.

The surface roughness of a pipe can be controlled mainly by adjusting the working temperature in its drawing. In addition, the surface roughness may be affected by the drawing speed, a lubricant used for working, and so forth. The axial residual tensile stress may be adjusted through the setting of drawing conditions (temperature, working ratio), etc. The differential outside diameter may be controlled through the drawing die configuration or by controlling the drawing temperature, drawing direction, etc.

In its tenth aspect, the present invention provides a magnesium base alloy pipe having the above-described chemical composition, wherein the pipe has a noncircular external configuration in cross section.

Most typically, both the inner and outer walls of a pipe are circular (concentric to each other) in cross section. However, the magnesium base alloy pipe according to the present invention having also improved toughness may be easily fabricated as various odd-shaped pipes such as those having elliptical, rectangular, polygonal, or other cross sections, not limited to circular pipes. A process for forming a noncircular pipe may be readily accommodated by modifying or changing the die configuration. Further, there may be a case where it is desired to form such a pipe for any structural material as having concavities and convexities partially in its external surface with its cross sections varying in shape locally along its longitudinal direction. Such an odd-shaped pipe having cross sections varying in shape locally along the longitudinal direction may be obtained by subjecting a drawn pipe to form rolling. Even when embodied as odd-shaped pipes, the magnesium base alloy pipe according to the present invention can have similar desirable properties as properties of those pipes having the same circular cross-section through their entire lengths and may be applied also to structural materials such as various kinds of frame materials including materials for bicycles, motorcycles and so on.

In its eleventh aspect, the present invention provides a magnesium base alloy pipe having the above-described chemical composition, wherein the pipe has a wall thickness of 0.5 mm or below.

So far, the drawing technique has not been able to substantially provide any magnesium base alloy pipes withstanding their practical use, and even those magnesium base alloy pipes produced by extrusion exceed 1.0 mm in wall thickness. According to the present invention, a thin-walled magnesium base alloy pipe can be obtained through drawing by using prescribed drawing conditions to be described herein later. Especially, magnesium base alloy pipes having a wall thickness of 0.7 mm or below, preferably 0.5 mm or below, may be provided also.

Such thin-walled alloy pipes are obtained by drawing. Heretofore, the production of magnesium base alloy pipes has been limited to short-length products by extrusion or like processes at the best due to difficulties involved in their working. The elongation of the prior art magnesium base alloy pipes have varied widely from 5 to 15% and their tensile strength were at the level of about 240 MPa at the best. According to the present invention, thin-walled alloy pipes having improved toughness and strength can be produced by drawing.

In its twelfth aspect, the present invention provides a magnesium base alloy pipe having the above-described chemical composition, wherein the pipe comprises a butted pipe having longitudinally a uniform outside diameter with its inside diameters at its opposite end portions being smaller than that of its intermediate portion.

Since the magnesium base alloy pipe of the present invention has high strength and toughness, it may be readily formed into a butted pipe and is applicable to bicycle flames, etc. Generally, the butted pipe has a uniform outside diameter longitudinally, while its inside diameters being reduced at its opposite ends as compared with its intermediate portion.

(Method of Manufacturing Magnesium Base Alloy Pipes)

In one aspect, the method of manufacturing the magnesium base alloy pipes according to the present invention comprises:

a step of providing a pipe blank of any one of the following magnesium base alloys (A) through (C):

(A) a magnesium base alloy containing about 0.1-12.0 mass % of Al;

(B) a magnesium base alloy containing about 0.1-12.0 mass % of Al plus at least one ingredient to be selected from the group consisting of about 0.1-2.0 mass % of Mn, 0.1-5.0 mass % of Zn and 0.1-5.0 mass % of Si; or

(C) a magnesium base alloy containing about 1.0-10.0 mass % of Zn and 0.1-2.0 mass % of Zr;

a metal pointing step for pointing said pipe blank; and

a drawing step for drawing the resultant pointed pipe blank, wherein said drawing step is executed at a drawing temperature 50° C. or above.

By executing the drawing the in such a temperature zone, the magnesium base alloy pipe can be improved in at least one of strength and toughness. Especially, a magnesium base alloy pipe best-suited to structural materials requiring a light weight in addition to strength can be obtained, such structural materials including those pipes used for chairs, tables, pickels (ice axe) , or pipes for bicycle frames or like frames.

In another aspect, the method of manufacturing the magnesium base alloy pipes according to the present invention comprises:

a step of providing a pipe blank of any one of the following magnesium base alloys (A) through (C):

(A) a magnesium base alloy containing about 0.1-12.0 mass % of Al;

(B) a magnesium base alloy containing about 0.1-12.0 mass % of Al plus at least one ingredient to be selected from the group consisting of about 0.1-2.0 mass % of Mn, 0.1-5.0 mass % of Zn and 0.1-5.0 mass % of Si; and

(C) a magnesium base alloy containing about 1.0-10.0 mass % of Zn and 0.1-2.0 mass % of Zr;

a metal pointing step for pointing said pipe blank; and

a drawing step for drawing the resultant pointed pipe blank, wherein said pointing step is executed by heating at least a front working end of the pipe blank entering a pointing machine. It is preferred that when the pipe blank is fed in the pointing machine at least its front end portion is heated at 50-450° C., more preferably 100-250° C.

The pointing step thus executed as involving heating is effective for preventing the resultant pipe from undergoing cracking.

According to the present invention, the magnesium base alloy pipes are manufactured through the following process steps: providing pipe blanks→(film coating)→pointing→drawing→(heat treatment)→straightening. Among these steps, the film coating and heat treatment are performed as required. Hereafter, each of these process steps will be described in detail.

According to the present invention, pipes produced by casting or extrusion may be used as the pipe blanks. Of course, pipes drawn by the method of the present invention may be also used as the pipe blanks for further processing.

It is preferred that the pipe blank is lubricated at least its front end portion before drawing. The film coating, which is one type of lubrication, is accomplished by coating the pipe blank with a lubricant. For the lubricant coating, it is preferred to use a material exhibiting in drawing an adequate thermal resistance at the drawing temperature and having a small surface frictional resistance as coating. As such materials, fluorine-based resins such as a polytetrafluoroethylene (PTFE) and a tetrafluoro-perfluoroalkyl vinyl ether resin (PFA) are preferred, for example. More specifically, the film coating may be accomplished, for example, by first dispersing a water-dispersible PTFE or PFA in water to prepare its aqueous dispersion liquid, then immersing a pipe blank in this dispersion liquid, and subsequently heating the wet pipe blank at about 300-450° C. to form PTFE or PFA coating on the pipe surface. The lubricant coating formed by this film coating remains in the drawing step to be described herein later and acts to prevent seizing of the pipe blank. For the pipe blanks subjected to the film coating, a separate immersion in lubricant step as described herein later may or may not be applied in combination therewith.

The pointing is done to reduce the diameter of an end of a pipe blank so that the end of the pipe blank may be inserted into a die hole in the succeeding drawing process. For this pointing, is used a pointing machine such as a swaging machine. The pointing is performed by heating at least the front working end of the pipe blank at 50-450° C. This temperature shall be referred to herein after as an “inlet temperature.” The “front working end” herein referred to is a front end portion of the pipe blank where it is reduced in diameter by a pointing machine. More preferably, the inlet temperature ranges from 100 to 250° C. The inlet temperature is a temperature of the pipe blank at its front working end just before it is fed in the pointing machine.

For this purpose, means for heating the pipe blank are not particularly limited. For example, the pipe blank temperature at its front end may be controlled by first heating it by means of a suitable heater in advance and then appropriately varying the time elapsing before it is fed in a swaging machine. However, it is desired to minimize the temperature drop before the pipe blank is fed in the pointing machine after its heating. Especially, it is preferred to heat a part (usually die) of the pointing machine contacting the pipe blank. It is also preferred that the pointing is performed with a heat insulating material made of a magnesium base alloy, or other alloy or a metal inserted in the front end of the pipe blank. When the pipe blank is fed in the swaging machine, the pipe blank begins to cool due to its contact with the die. However, the existence of the heat insulating material acts to deter the temperature drop at the end of the pipe blank during pointing so as to permit the pointing step to be executed while inhibiting cracking of the pipe. To cite a typical example of the heat insulating materials, copper or like materials that are easier to work than the magnesium base alloy may be employed.

Working ratio (outside diameter reduction ratio) in the pointing step is preferably 30% or below. If the working ration exceeds 30%, the pipe blank tends to undergo cracking in the course of pointing. For inhibiting cracking more assuredly, the working ratio should be preferably 15% or below or, more preferably, 10% or below.

The thus pointed pipe blank is then subjected to the drawing process. The drawing step is executed by passing the pipe blank through a die or the like. For this, any time-proven technique for pipe drawing involving copper alloys, aluminium alloys or other alloys may be employed. Such techniques includes, for example, (1) plain drawing in which a pipe blank is passed through a hole die without providing any specific member inside the pipe blank, (2) plug drawing using a plug provided inside the pipe blank, and (3) mandrel drawing using a mandrel passing through a die. The plug drawing includes fixed plug drawing in which a plug 2 having a longer straight portion is fixed at the front end of a bearing rod 1 and the pipe blank 4 is subjected to drawing through a space defined between the plug 2 and the die 3, as shown in FIG. 1(A). Besides, the plug drawing includes: floating plug drawing which employs a plug 2 without using a bearing rod, as shown in FIG. 1(B); and semi-floating plug drawing in which a plug 2 having a shorter straight portion is fixed at the front end of the bearing rod 1 and the drawing is performed through a space defined by the plug 2 and the die 3, as shown in FIG. 1(C). While, in the mandrel drawing, a mandrel 5 passing through the die 3 is disposed through the entire pipe blank length, and the drawing is accomplished through a space defined by the die 3 and the mandrel 5, as shown in FIG. 1(D). In this connection, the drawing can be carried out more smoothly if the mandrel is coated with a lubricant. Especially, the mandrel drawing is suitable for producing an alloy pipe having a wall thickness of 0.7 mm or below.

Among others, a combination of the plain drawing and the plug drawing facilitates fabrication of butted pipes. That is, the drawing process may be executed in the following manner, for example. First, one end of a pipe blank is passed through a die and the pipe blank is subjected to plain drawing without squeezing its wall between the inner wall of the die and a plug. Then, the intermediate portion of the pipe blank is subjected to plug drawing so as to squeeze its pipe blank between the inner wall of the die and the plug. Further, the other end of the pipe blank is subjected also to plain drawing without squeezing its wall between the inner wall of the die and the plug. This process can form a butted pipe with thick-walled opposite end portions and a thin-walled intermediate portion. Besides, in the mandrel drawing using a mandrel passed through the die, a butted pipe may be formed by using a mandrel having its diameter varied along its length. For this, it may be appropriate that the pipe blank is drawn by grasping the front working end of the pipe blank extending out of the die exit. For drawing the pipe blank as it is grasped, a drawbench or a like means may be used. Further, if this drawing operation is repeated two or more times by using varied diameters of die orifice, butted pipes may also be formed effectively. By repeating the drawing more than once with varied diameters of die orifice, a butted pipe having a great difference in thickness between its thin-walled and thick-walled portions can be manufactured.

Further, according to the present invention, the drawing is executed at 50° C. or higher temperatures. Drawing temperatures above approx. 50° C. allows easier working of pipes. However, since the strength decreases as the drawing temperature increases, the temperature is preferably below approx. 350° C. The drawing temperature ranges preferably from 100° C. to 300° C., more preferably from 100° C. to 200° C., or most preferably from 100° C. to 150° C.

The drawing temperature herein referred to represents a temperature of the pipe blank before or after it is fed in the die or temperature setting at a heating means. For example, the drawing temperature may be a temperature of the pipe blank just before it is fed in the die or a temperature of the pipe blank just after the die exit (namely drawn pipe temperature), or a temperature set on a heater when such a heater is provided at a place just before the die. In any case, there is no substantial difference among them practically. However, since the pipe blank temperature just after the die exit tends to vary with such factors as working ratio, working speed, die temperature, pipe configuration, and type of drawing (mandrel drawing, plug drawing, etc.), it is easier to specify the drawing temperature as a temperature of the pipe blank just before the die inlet.

For heating to this drawing temperature, the pipe blank may be heated only at its front end portion, or it may be heated wholly. Whatever the case may be, the heating applied in the above-described manner is effective for producing a magnesium base alloy pipe excellent in both strength and toughness. Especially, it is preferred to heat an initial working portion of the pipe blank that first contacts at least the die. The initial working portion differs from the aforementioned front working end for pointing. That is to say, in the drawing operation, since the pipe blank contacts a die (and a plug or a mandrel) first by the root portion of its front working end and its effective drawing is started thereat, the initial working portion means this starting point of drawing, i.e. the root portion of the front working end. More specifically, the initial working portion in the plain drawing is a position on the pipe blank where it first contacts the die, while for the plug drawing the initial working portion is a position on the pipe blank where it first contacts the die and the plug, and for the mandrel drawing the initial working portion is a point on the pipe blank where it first contacts the die and the mandrel.

For heating a pipe blank, it is preferred that the pipe blank is heated by immersing the same in a preheated lubricant, or is heated in an atmosphere furnace or in a high-frequency heating furnace. Alternatively, it may be heated by heating the drawing die. Among others, the immersion of the pipe blank in preheated lubricant is preferred in that heating is accomplished along with lubrication. The temperature of the pipe blank at the die exit (exit temperature) may be adjusted by varying the time (cooling time) it stands to cool before it is fed in the drawing die after heating. For lubricating the pipe blank, forced lubrication may be employed in addition to film coating or immersion in lubricant described above. For the forced lubrication, a pressurized lubricant is forcedly supplied into a gap between the die and the pipe blank during drawing. The lubricant may be of powder or oil.

By drawing the pipe blank by applying thereto a combination of its lubrication and heating as described above, it is possible to inhibit seizing or fractures occurring in drawing. Especially, it is preferred that the pipe blank is drawn under predetermined heating conditions after the above-described pointing process.

For example, the pipe blank is drawn based on plug-drawing using a die in combination with a plug, where only the initial working portion of the pipe blank may be heated without otherwise heating its remaining portion during the drawing, or the pipe blank may be drawn as it cools down naturally from a temperature to which it was heated beforehand. The heating temperature of the initial working portion is preferably in the range of 150° C. or above but below 400° C.

According to the present invention, the heating rate to the aforementioned drawing temperature is preferably in the range of 1° C./sec.-100° C./sec. Meanwhile, the drawing speed is preferably 1 m/min. or above.

The drawing may be executed in multiple passes and/or a multistep process. By executing the drawing in such repeated multiple passes, it is possible to obtain smaller-diameter pipes.

Further, according to the present invention, it is preferred that the reduction in cross-sectional area (hereinafter shall be referred to as “area reduction ratio”) in 1 drawing pass is 5% or above. A low working ratio yields only a small increase in strength, while drawing with an area reduction ratio of 5% or above facilitates fabrication of magnesium base alloy pipes having adequate strength and toughness. More preferably, the area reduction ratio per drawing pass should be 10% or above or, most preferably, 20% or above. However, since an excessively large working ratio is impractical, the area reduction ratio per pass ranges up to about 40%.

It is also preferred that the total area reduction ratio in drawing is 15% or above. More preferably, the total area reduction ratio is 25% or above. By drawing the pipe blank with the total area reduction ratio not less than 15% as above, is allowed production of magnesium base alloy pipes combining strength and toughness in balance.

Preferably, the cooling rate of the work after drawing is not less than 0.1° C./sec. This is because a cooling rate below this lower limit will act to accelerate grain growth. For cooling, air cooling including air blast cooling, etc. may be used, and the cooling rate may be controlled by adjusting the wind velocity, air flow or the like.

By drawing a pipe blank having a chemical composition according to the present invention by the above-described method, a magnesium base alloy pipe having an elongation of 3% or above and tensile strength of 350 MPa or above can be produced.

Further, by heating the drawn pipe at above approx. 150° C. (preferably above approx. 200° C.), the relief of strain induced in drawing and the recrystallization in the alloy are accelerated to permit an additional improvement in toughness. This heat treatment is performed at temperatures preferably 300° C. or below. The retention time of this heating temperature ranges preferably from about 5 to 60 minutes. More preferably, the lower limit of the retention time is in the range of about 5 to 15 minutes with its upper limit in the range of about 20 to 30 minutes. By this heat treatment, a magnesium base alloy pipe having approx. 15-20% tensile strength and approx. 250-350 MPa elongation can be produced. It is also to be noted here that the pipe produced by the method of the present invention can be used practically as intended without applying the heat treatment at temperatures above approx. 150° C. after drawing.

### BRIEF DESCRIPTION OF DRAWINGS

FIG. 1 shows schematic diagrams (A) through (D) illustrating typical methods of drawing pipes, respectively;

FIG. 2 shows a graph illustrating a relationship between the outside diameter and the working ratio of pipes of an Az31 alloy;

FIG. 3 is shows a similar graph illustrating a relationship between the outside diameter and the working ratio of pipes of an Az61 alloy;

FIG. 4 shows a graph illustrating a relationship between the working ratio and the drawing force;

FIG. 5 is a micrograph showing a structure of metal of the alloy specimen No. 17-8 in the experimental example 2-3 according to the present invention;

FIG. 6 shows schematic diagrams (A) and (B) illustrating processes of manufacturing a butted tube, with (A) representing plain drawing process and (B) a plug drawing process.

FIG. 7 shows a longitudinal section of a butted tube.

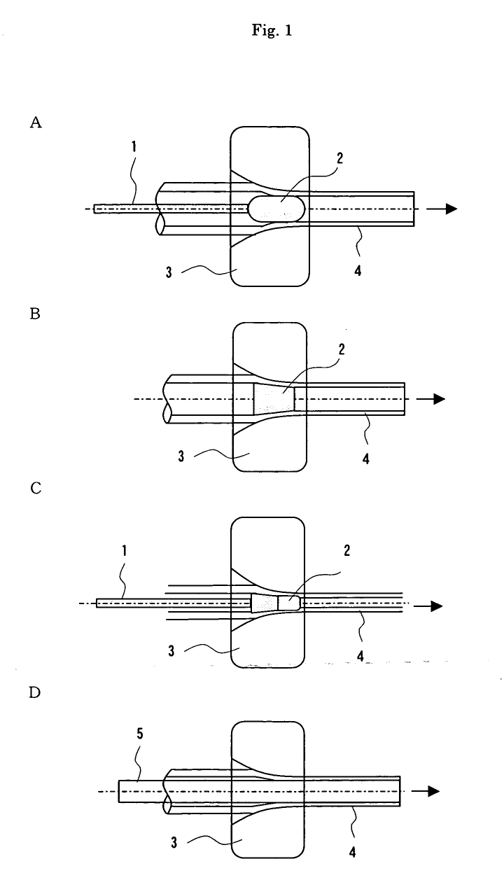

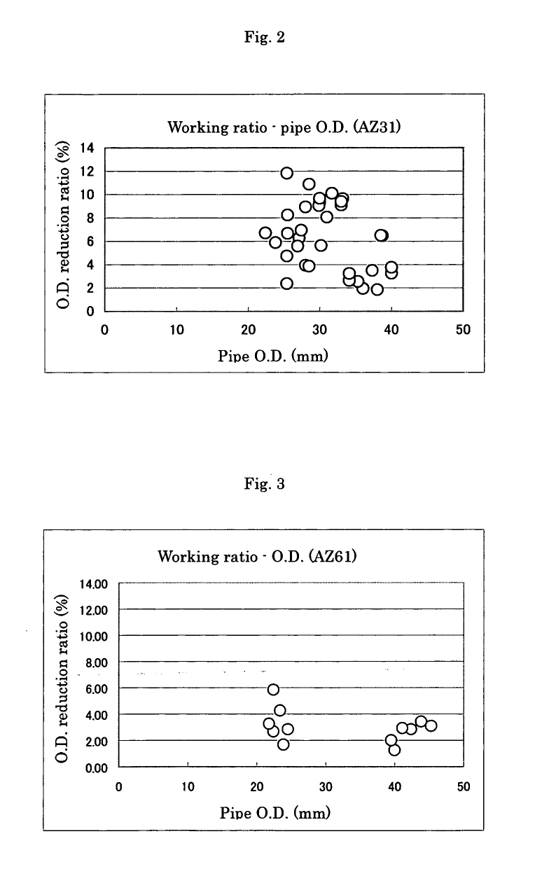

### BEST MODE FOR CARRYING OUT THE INVENTION

Hereinafter, the present invention will be described in detail based on the preferred embodiments thereof such as those included in the following experimental examples.

### EXPERIMENTAL EXAMPLE 1-1

An extruded pipe (outside diameter: 15.0 mm, wall thickness: 1.5 mm) of an alloy subject to the ASTM AZ31 (shall be referred to as AZ31 alloy and like nomenclature shall apply hereinafter) and an extruded pipe of an AZ61 alloy having the same configuration as above were drawn, respectively, at varied temperatures to be reduced to 12.0 mm in outside diameter, thus yielding various specimens of drawn magnesium base alloy pipes. The AZ31 alloy of the extruded pipe used was a magnesium base alloy containing 2.9 mass % of Al, 0.77 mass % of Zn and 0.40 mass % of Mn with the balance composed of Mg as a base material and unavoidable impurities, while the AZ61 alloy of the extruded pipe was a magnesium base alloy containing 6.4 mass % of Al, 0.77 mass % of Zn and 0.35 mass % of Mn with the balance likewise comprising Mg and unavoidable impurities. The drawing was accomplished in two passes of plain drawing, with the first pass reducing the outside diameter to 13.5 mm and the second pass reducing the same to 12.0 mm. The first and the second passes yielded area reduction ratios of 10.0% and 12.3%, respectively, with the total area reduction ratio of 21.0%. After drawing, the pipes were air-cooled at a rate of 1-5° C./sec. For heating the pipes in drawing, a heater was provided before a die, and the working temperature (drawing temperature) was observed in terms of the heating temperature set on the heater. This applies also in experimental examples 1-2 through 1-10 to be described herein later. The heating rate to the drawing temperature was in the range of 1-2° C./sec., and the drawing speed was approx. 10 m/min. The resultant drawn pipes had the properties as shown in Table 1.

TABLE 1

| | | | | | Elon- | | |
|---|---|---|---|---|---|---|---|
| | | Work- | Area | | gation | 0.2% | |
| | Speci- | ing | reduction | Tensile | after | proof | |
| Alloy | mens | temp. | ratio | strength | fracture | stress | YP |
| type | No. | (° C.) | (%) | (MPa) | (%) | (MPa) | ratio |
| AZ31 | 1-1 | Not worked | | 245 | 9.0 | 169 | 0.69 |
| | | (extruded pipe) | | | | | |
| | 1-2 | 20 | 21 | Working impossible | | | |
| | 1-3 | 50 | 21 | 395 | 6.0 | 380 | 0.96 |
| | 1-4 | 100 | 21 | 380 | 8.0 | 362 | 0.95 |
| | 1-5 | 200 | 21 | 345 | 10.5 | 321 | 0.93 |
| | 1-6 | 300 | 21 | 303 | 11.5 | 279 | 0.92 |
| AZ61 | 1-7 | Not worked | | 285 | 6.0 | 188 | 0.66 |
| | | (extruded pipe) | | | | | |
| | 1-8 | 20 | 21 | Working impossible | | | |
| | 1-9 | 50 | 21 | 462 | 6.0 | 432 | 0.94 |
| | 1-10 | 100 | 21 | 451 | 8.0 | 422 | 0.94 |
| | 1-11 | 200 | 21 | 439 | 8.5 | 408 | 0.93 |
| | 1-12 | 300 | 21 | 412 | 10.5 | 382 | 0.93 |

As shown in Table 1, the extruded pipes (specimens No. 1-1 and 1-7 representing comparative examples) of AZ31 and AZ61 alloys, respectively, have tensile strength of 290 MPa or below, 0.2% proof stress of 190 MPa or below, a YP ratio of 0.70 or below, and an elongation (elongation after fracture) of 6-9%. While, the drawn pipe specimens No. 1-3 through 1-6 and the specimens 1-9 through 1-12 drawn at temperatures above 50° C., embodying the present invention, have tensile strength above 300 MPa, 0.2% proof stress above 250 MPa, a YP ratio above 0.90 in addition to an elongation duly above 5%. Thus, it will be clearly understood that the specimens prepared according to the present invention are improved in their strength without greatly reducing its toughness. Among those last specimens, the No. 1-4 through 1-6 specimens and No. 1-10 through 1-12 specimens which were drawn at temperatures from 100° C. to 300° C. are improved particularly in toughness with their further higher elongations above 8%. Therefore, it will be understood that the drawing temperature is preferably in the range of 100° C. to 300° C. in view of elongation after fracture. When the drawing temperature exceeded 300° C. the rate of increase in tensile strength became low, while the specimens No. 1-2 and 1-8 subjected to drawing at a room temperature, namely 20° C., representing another comparative examples, could not actually withstand working due to breakage. Thus, it turns out that the balance of strength and toughness is more improved by employing a drawing temperature in the range of approx. 50° C. to 300° C. (preferably 100° C. to 300° C.).

For the resultant specimens No. 1-3 through 1-6 and 1-9 through 1-12, it was possible to apply drawing even in 3 or more passes. These specimens No. 1-3 through 1-6 and 1-9 through 1-12 had surface roughness Rz of 5 μm or below and an axial residual tensile stress of 80 MPa or below in their pipe surfaces as determined by X-ray diffraction. Besides, these pipe specimens had a differential outside diameter (difference between the largest and the smallest outside diameters in a cross section of the pipe) of 0.02 mm or below.

### EXPERIMENTAL EXAMPLE 1-2

An extruded pipe (outside diameter: 15.0 mm, wall thickness: 1.5 mm) of an AZ31 alloy and an extruded pipe of an AZ61 alloy having the same configuration as above were drawn, respectively, with varied reduction ratios, consequently yielding various specimens of drawn magnesium base alloy pipes having different outside diameters. The AZ31 alloy of the extruded pipe used was a magnesium base alloy containing 2.9 mass % of Al, 0.77 mass % of Zn and 0.40 mass % of Mn with the balance composed of Mg as a base material and unavoidable impurities, while the AZ61 alloy of the extruded pipe was a magnesium base alloy containing 6.4 mass % of Al, 0.77 mass % of Zn and 0.35 mass % of Mn with the balance likewise comprising Mg and unavoidable impurities. The drawing was accomplished in one pass of plain drawing by using varied area reduction ratios of 5.5% (O.D. after a drawing: 14.20 mm), 10.0% (O.D. after a drawing: 13.5 mm) and 21.0% (O.D. after a drawing: 12.0 mm), respectively. The drawing temperature was 150° C., and the cooling rate after drawing was 1-5° C./sec. The heating rate to the drawing temperature was in the range of 1-2° C./sec., and the drawing speed was 10 m/min. The resultant drawn pipes had the properties as shown in Table 2.

TABLE 2

| | | | | | Elon- | | |
|---|---|---|---|---|---|---|---|
| | | Work- | Area | | gation | 0.2% | |
| | Speci- | ing | reduction | Tensile | after | proof | |
| Alloy | men | temp. | ratio | strength | fracture | stress | YP |
| type | No. | (° C.) | (%) | (MPa) | (%) | (MPa) | ratio |
| AZ31 | 2-1 | Not worked | | 245 | 9.0 | 169 | 0.69 |
| | | (extruded pipe) | | | | | |
| | 2-2 | 150 | 5.5 | 302 | 10.5 | 275 | 0.91 |
| | 2-3 | 150 | 10 | 325 | 9.5 | 302 | 0.93 |
| | 2-4 | 150 | 21 | 362 | 8.0 | 342 | 0.94 |
| AZ61 | 2-5 | Not worked | | 285 | 6.0 | 188 | 0.66 |
| | | (extruded pipe) | | | | | |
| | 2-6 | 150 | 5.5 | 362 | 10.5 | 327 | 0.90 |
| | 2-7 | 150 | 10 | 408 | 9.5 | 382 | 0.94 |
| | 2-8 | 150 | 21 | 445 | 8.0 | 425 | 0.96 |

No. 2-2 through 2-4 and the specimens 2-6 through 2-8 drawn with an area reduction ratio above 5%, embodying the present invention, have tensile strength above 300 MPa, 0.2% proof stress above 250 MPa, a YP ratio above 0.90 in addition to a high elongation above 8%. Thus, it will be clearly understood that by drawing with an area reduction ratio above 5% the specimens prepared according to the present invention are improved in their strength without greatly reducing its toughness.

These specimens No. 2-2 through 2-4 and 2-6 through 2-8 had surface roughness Rz of 5 μm or below and an axial residual tensile stress of 80 MPa or below in their pipe surfaces as determined by X-ray diffraction. Besides, these pipe specimens had a differential outside diameter of 0.2 mm or below.

### EXPERIMENTAL EXAMPLE 1-3

In this experimental example, to prepare drawn magnesium base alloy pipes, three types of extruded pipes were drawn at 150° C. to be reduced in outside diameter to 12.0 mm, respectively, including an extruded pipe of a magnesium base alloy (AZ10 alloy) containing 1.2 mass % of Al, 0.4 mass % of Zn and 0.3 mass % of Mn with the balance composed of Mg as a base material and unavoidable impurities, an extruded pipe of an AS41 magnesium base alloy containing 4.2 mass % of Al, 1.0 mass % of Si and 0.40 mass % of Mn with the balance likewise comprising Mg and unavoidable impurities and an extruded pipe of an AS21 magnesium base alloy containing 1.9 mass % of Al, 1.0 mass % of Si and 0.45 mass % of Mn with the balance likewise comprising Mg and unavoidable impurities. Each extruded pipe subjected to drawing was 15.0 mm in outside diameter and 1.5 mm in wall thickness. The drawing was performed in the same manner and under the same conditions as in the experimental example 1-1 above, except that the drawing temperature was fixed at 150° C. As comparative examples, specimens were prepared by drawing the respective corresponding extruded pipes in the same manner as above at 20° C. The resultant drawn pipes had the properties as shown in Table 3.

TABLE 3

| | | | | | Elon- | | |
|---|---|---|---|---|---|---|---|
| | | Work- | Area | | gation | 0.2% | |
| | Speci- | ing | reduction | Tensile | after | proof | |
| Alloy | men | temp. | ratio | strength | fracture | stress | YP |
| type | No. | (° C.) | (%) | (MPa) | (%) | (MPa) | ratio |
| AZ10 | 3-1 | Not worked | | 210 | 10 | 120 | 0.57 |
| | | (extruded pipe) | | | | | |
| | 3-2 | 20 | 21 | Working impossible | | | |
| | 3-3 | 150 | 21 | 325 | 9.0 | 304 | 0.94 |
| AS41 | 3-4 | Not worked | | 251 | 9.0 | 148 | 0.59 |
| | | (extruded pipe) | | | | | |
| | 3-5 | 20 | 21 | Working impossible | | | |
| | 3-6 | 150 | 21 | 371 | 9.0 | 345 | 0.93 |
| AS21 | 3-7 | Not worked | | 210 | 10.5 | 135 | 0.64 |
| | | (extruded pipe) | | | | | |
| | 3-8 | 20 | 21 | Working impossible | | | |
| | 3-9 | 150 | 21 | 330 | 9.5 | 310 | 0.94 |

AS21 alloys, respectively, have tensile strength of 260 MPa or below, 0.2% proof stress of 150 MPa or below, a YP ratio of 0.65 or below, and an elongation of 9-10.5%. While, the drawn pipe specimens No. 3-3, 3-6 and 3-9 drawn with an area reduction ratio above 5%, embodying the present invention, have tensile strength above 300 MPa, 0.2% proof stress above 250 MPa, a YP ratio above 0.90 in addition to a high elongation above 9.0%. Thus, it will be clearly understood that by drawing with an area reduction ratio above 5% the specimens prepared according to the present invention are improved in their strength without greatly reducing its toughness. These specimens No. 3-3, 3-6 and 3-9 had surface roughness Rz of 5 μm or below and an axial residual tensile stress of 80 MPa or below in their pipe surfaces as determined by X-ray diffraction. Besides, these pipe specimens had a differential outside diameter of 0.02 mm or below.

### EXPERIMENTAL EXAMPLE 1-4

An extruded pipe (outside diameter: 15.0 mm, wall thickness: 1.5 mm) of an Az31 alloy and an extruded pipe of an AZ61 alloy having the same configuration as above were drawn, respectively, to be reduced to 12.0 mm in outside diameter and the resultant drawn pipes were heat-treated at varied temperatures to obtain various specimens of drawn magnesium base alloy pipes. The AZ31 alloy of the extruded pipe used was a magnesium base alloy containing 2.9 mass % of Al, 0.77 mass % of Zn and 0.40 mass % of Mn with the balance composed of Mg as a base material and unavoidable impurities, while the AZ61 alloy of the extruded pipe was a magnesium base alloy containing 6.4 mass % of Al, 0.77 mass % of Zn and 0.35 mass % of Mn with the balance likewise comprising Mg and unavoidable impurities. The drawing was accomplished at 150° C. in one pass of plain drawing. The area reduction ratio was 21.0%. For heating the pipes in drawing, a heater was provided before a die, and the drawing temperature was observed in terms of the heating temperature set on the heater. The heating rate to the drawing temperature was in the range of 1-2° C./sec., and the drawing speed was 10 m/min. After drawing, the pipes were air-cooled to a room temperature at a rate of about 1-5° C./sec. and thereafter heated again to be subjected to heat-treatment at 100-300° C. for 15 minutes.

The resultant pipe specimens were studied for their tensile strength, 0.2% proof stress, elongation after fracture, YP ratio, and the grain size. For determining the average grain size, a texture in a cross section of the wall of each pipe specimen was microscopically magnified, and sizes of multiple crystal grains within the microscopic field were measured and averaged. The resultant drawn pipes had the properties as shown in Tables 4 and 5.

TABLE 4

| | | Heat treatment | Tensile | 0.2% proof | | Elongation | Average grain |
|---|---|---|---|---|---|---|---|
| Alloy | Specimen | temp. | strength | stress | | after fracture | size |
| type | No. | (° C.) | (MPa) | (MPa) | YP ratio | (%) | (μm) |
| AZ31 | 4-1 | Without | 362 | 342 | 0.94 | 7.5 | 17.5 |
| | 4-2 | 100 | 360 | 335 | 0.93 | 7.0 | 17.2 |
| | 4-3 | 150 | 335 | 298 | 0.89 | 12.5 | Duplex grain |
| | 4-4 | 200 | 312 | 265 | 0.85 | 17.0 | 3.8 |
| | 4-5 | 250 | 301 | 240 | 0.80 | 19.0 | 4.3 |
| | 4-6 | 300 | 295 | 225 | 0.76 | 20.0 | 7.5 |
| | 4-7 | Extruded pipe | 245 | 169 | 0.69 | 9.0 | 18.8 |

TABLE 5

| | | Heat treatment | Tensile | 0.2% proof | | Elongation | Average grain |
|---|---|---|---|---|---|---|---|
| Alloy | Specimen | temp. | strength | stress | | after fracture | size |
| type | No. | (° C.) | (MPa) | (MPa) | YP ratio | (%) | (μm) |
| AZ61 | 5-1 | Without | 445 | 425 | 0.96 | 7.5 | 17.3 |
| | 5-2 | 100 | 443 | 421 | 0.95 | 6.0 | 17.0 |
| | 5-3 | 150 | 425 | 380 | 0.89 | 12.0 | Duplex grain |
| | 5-4 | 200 | 375 | 325 | 0.87 | 18.0 | 3.9 |
| | 5-5 | 250 | 359 | 292 | 0.80 | 19.0 | 4.6 |
| | 5-6 | 300 | 338 | 261 | 0.77 | 18.0 | 7.8 |
| | 5-7 | Extruded pipe | 285 | 188 | 0.66 | 6.0 | 20.3 |

As clearly understood from Tables 4 and 5, for both the AZ31 and AZ61 alloys, the specimens No. 4-3 through 4-6 and 5-3 through 5-6 subjected to heat treatment at temperatures above 150° C. after drawing, embodying the present invention, are shown to have a substantially improved elongation after fracture and strength, as compared with those extruded pipes which were subjected to neither drawing nor heat treatment (specimens No. 4-7 and 5-7 representing comparative examples). Specifically, these specimens No. 4-3 through 4-6 and 5-3 through 5-6 have tensile strengths above 280 MPa, 0.2% proof stress above 220 MPa, a YP ratio in the range of 0.75 to less than 0.90 and an elongation above 12%, showing improvements in ductility and strength in balance. Especially, it turns out that the specimens No. 4-4 through 4-6 and 5-4 through 5-6 for which the heat treatment was carried out at temperatures above 200° C. are further improved in toughness with their elongations higher than 17%. Among those, the specimens No. 4-4, 4-5 and 5-4, 5-5 involving a heat treatment temperature in the range of 200° C.-250° C. had tensile strength above 300 MPa, 0.2% proof stress above 240 MPa, a YP ratio in the range of 0.80 to less than 0.90 and an elongation above 17%, showing improvements in strength and ductility further in balance.

Further, it is shown that as compared with the specimens No. 4-2 and 5-2 heat-treated at 100° C. after drawing and with the specimens No. 4-1 and 5-1 not subjected to heat treatment after drawing, the specimens No. 4-3 through 4-6 and 5-3 through 5-6 which underwent heat treatment at temperatures above 150° C. after drawing are greatly improved in their elongation, although their tensile strength, 0.2% proof stress and YP ratio is somewhat reduced. On the other hand, since the rate of increase in tensile strength decreases if the heat treatment temperature exceeds 300° C., it is preferred that the heat treatment is performed at a temperature of 300° C. or below. Thus, it turns out that by executing the heat treatment at a temperature in the range of 150° C. to 300° C. (preferably 200° C. to 300° C.) after a drawing, magnesium base alloy pipes having can have high strength as well as improved toughness.

Regarding the average grain size of the specimens obtained in the experiment, the extruded pipe specimens not subjected to drawing (specimens No. 4-7 and 5-7) and the specimens heat-treated at temperatures of 100° C. or below (specimens No. 4-1, 4-2 and 5-1,5-2) have a larger grain size above 15 μm, as shown in Tables 4 and 5. On the other hand, the specimens heat-treated at temperatures above 200° C. (specimens No. 4-4 through 4-6 and 5-4 through 5-6) have fine grains with an average grain size of 10 μm or below. Among those, the specimens heat-treated at a temperature of 200-250° C. (specimens No. 4-4, 4-5 and 5-4, 5-5) have an average grain size of 5 μm or below. Further, the specimens heat-treated at 150° C. (specimens No. 4-3 and 5-3) had a mixed texture comprising grains having a 3 μm or smaller average grain size and grains having a 15 μm or larger average grain size, in which the grains area share by 3 μm or smaller grains was above 10%. Thus, it turns out that an alloy texture comprising fine grains or a mixed texture having fine grains and coarse grains yields a magnesium base alloy pipe having strength and toughness in balance as above.

For those specimens subjected to heat treatment (specimens No. 4-3 through 4-6 and 5-3 through 5-6) at 150° C.-300° C., it was possible to apply drawing in two or more multiple passes. These specimens No. 4-3 through 4-6 and 5-3 through 5-6 had surface roughness Rz of 5 μm or below. Further, these specimens had an axial residual tensile stress of 80 MPa or below in their pipe surfaces as determined by X-ray diffraction. Besides, these pipe specimens had a differential outside diameter (difference between the largest and the smallest outside diameters in a cross section of the pipe) of 0.02 mm. or below.

### EXPERIMENTAL EXAMPLE 1-5

In this experimental example, three types of extruded pipes were drawn at 150° C. to be reduced in outside diameter to 12.0 mm, respectively, including an extruded pipe of a magnesium base alloy (AZ10 alloy) containing 1.2 mass % of Al, 0.4 mass % of Zn and 0.3 mass % of Mn with the balance composed of Mg as a base material and unavoidable impurities, an extruded pipe of an AS41 magnesium base alloy containing 4.2 mass % of Al, 1.0 mass % of Si and 0.40 mass % of Mn with the balance likewise comprising Mg and unavoidable impurities and an extruded pipe of an AS21 magnesium base alloy containing 1.9 mass % of Al, 1.0 mass % of Si and 0.45 mass % of Mn with the balance likewise comprising Mg and unavoidable impurities. Then, the drawn pipes were subjected to heat treatment at 200° C. to prepare drawn magnesium base alloy pipe specimens. Each extruded pipe subjected to drawing was 15.0 mm in outside diameter and 1.5 mm in wall thickness. The drawing was performed in the same manner and under the same conditions as in the experimental example 1-1 above, except that the heat treatment after drawing was carried out at 200° C. As comparative examples, specimens were prepared in the same manner by changing this heat treatment temperature to 100° C. Further, the resultant pipe specimens were studied for their grain size in the same manner as in the experimental example 1-4 above. The resultant drawn pipe specimens had tensile strength, 0.2% proof stress, elongation after fracture, YP ratios and grain sizes as shown in Table 6.

TABLE 6

| | | Heat treatment | Tensile | 0.2% proof | | Elongation | Average grain |
|---|---|---|---|---|---|---|---|
| Alloy | Specimen | temp. | strength | stress | | after fracture | size |
| type | No. | (° C.) | (MPa) | (MPa) | YP ratio | (%) | (μm) |
| AZ10 | 6-1 | Without | 325 | 304 | 0.94 | 9.0 | 18.5 |
| | 6-2 | 100 | 322 | 301 | 0.93 | 9.0 | 18.0 |
| | 6-3 | 200 | 291 | 250 | 0.86 | 18.0 | 4.0 |
| | 6-4 | Extruded pipe | 210 | 120 | 0.57 | 10.0 | 20.1 |
| AS41 | 6-5 | Without | 371 | 345 | 0.93 | 9.0 | 19.3 |
| | 6-6 | 100 | 368 | 340 | 0.92 | 9.0 | 19.2 |
| | 6-7 | 200 | 325 | 276 | 0.85 | 18.5 | 3.8 |
| | 6-8 | Extruded pipe | 251 | 148 | 0.59 | 9.0 | 21.2 |
| AS21 | 6-9 | Without | 330 | 310 | 0.94 | 9.5 | 19.9 |
| | 6-10 | 100 | 328 | 305 | 0.93 | 9.0 | 19.5 |
| | 6-11 | 200 | 299 | 257 | 0.86 | 18.5 | 3.9 |
| | 6-12 | Extruded pipe | 210 | 135 | 0.64 | 10.5 | 20.2 |

As clearly understood from Table 6, for any of AZ10, AS41 and AS21 alloys, the specimens No. 6-3, 6-7 and 6-11 subjected to heat treatment at 200° C. after drawing, embodying the present invention, are shown to have a substantially improved elongation after fracture and strength, as compared with those extruded pipes which were subjected to neither drawing nor heat treatment (specimens No. 6-4, 6-8 and 6-12 representing comparative examples). Further, regarding the average grain size of the specimens obtained in the experiment, the extruded pipe specimens not subjected to drawing (specimens No. 6-4, 6-8 and 6-12), the drawn specimens not subjected to heat treatment (specimens No. 6-1, 6-5 and 6-9) and the specimens heat-treated at 100° C. (specimens No. 6-2, 6-6 and 6-10) have a larger grain size above 15 μm. On the other hand, the specimens heat-treated at temperatures at 200° C. (specimens No. 6-3, 6-7 and 6-11) have fine grains with an average grain size of 5 μm or below. These specimens No. 6-3, 6-7 and 6-11 had surface roughness Rz of 5 μm or below and an axial residual tensile stress of 80 MPa or below in their pipe surfaces as determined by X-ray diffraction. Besides, these pipe specimens had a differential outside diameter of 0.02 mm or below.

### EXPERIMENTAL EXAMPLE 1-6

An extruded pipe (outside diameter: 15.0 mm, wall thickness: 1.5 mm) of an ZK40 alloy and an extruded pipe of an ZK60 alloy having the same configuration as above were drawn, respectively, to be reduced to 12.0 mm in outside diameter and the resultant drawn pipes were heat-treated at varied temperatures to obtain various specimens of drawn magnesium base alloy pipes. The ZK40 alloy of the extruded pipe used was a magnesium base alloy containing 4.1 mass % of Zn and 0.5 mass % of Zr with the balance composed of Mg as a base material and unavoidable impurities, while the ZK60 alloy of the extruded pipe was a magnesium base alloy containing 5.5 mass % of Zn and 0.5 mass % of Zr with the balance likewise comprising Mg and unavoidable impurities. The drawing was accomplished at 150° C. in one pass of plain drawing. The area reduction ratio was 21.0%. For heating the pipes in drawing, a heater was provided before a die, and the drawing temperature was observed in terms of the heating temperature set on the heater. The heating rate to the drawing temperature was in the range of 1-2° C./sec., and the drawing speed was 10 m/min. After drawing, the pipes were air-cooled to a room temperature at a rate of about 1-5° C./sec. and thereafter heated again to be subjected to heat-treatment at 100-300° C. for 15 minutes.

The resultant pipe specimens were studied for their tensile strength, 0.2% proof stress, elongation after fracture, YP ratio, and the grain size. For determining the average grain size, a texture in a cross section of the wall of each pipe specimen was microscopically magnified, and sizes of multiple crystal grains within the microscopic field were measured and averaged. The resultant drawn pipes had the properties as shown in Tables 7 and 8.

TABLE 7

| | | Heat treatment | Tensile | 0.2% proof | | Elongation | Average grain |
|---|---|---|---|---|---|---|---|
| Alloy | Specimen | temp. | strength | stress | | after fracture | size |
| type | No. | (° C.) | (MPa) | (MPa) | YP ratio | (%) | (μm) |
| ZK40 | 7-1 | Without | 425 | 399 | 0.94 | 8.5 | 19.3 |
| | 7-2 | 100 | 422 | 392 | 0.93 | 8.0 | 18.5 |
| | 7-3 | 150 | 412 | 368 | 0.89 | 12.0 | Duplex grain |
| | 7-4 | 200 | 352 | 301 | 0.86 | 18.0 | 3.6 |
| | 7-5 | 250 | 341 | 276 | 0.81 | 19.0 | 4.4 |
| | 7-6 | 300 | 332 | 260 | 0.78 | 21.0 | 7.8 |
| | 7-7 | Extruded pipe | 275 | 201 | 0.73 | 8.0 | 19.8 |

TABLE 8

| | | Heat treatment | Tensile | 0.2% proof | | Elongation | Average grain |
|---|---|---|---|---|---|---|---|
| Alloy | Specimen | temp. | strength | stress | | after fracture | size |
| type | No. | (° C.) | (MPa) | (MPa) | YP ratio | (%) | (μm) |
| ZK60 | 8-1 | Without | 458 | 431 | 0.94 | 9.5 | 18.8 |
| | 8-2 | 100 | 452 | 422 | 0.93 | 9.0 | 18.9 |
| | 8-3 | 150 | 428 | 381 | 0.89 | 12.5 | Duplex grain |
| | 8-4 | 200 | 372 | 315 | 0.85 | 18.0 | 3.2 |
| | 8-5 | 250 | 358 | 289 | 0.81 | 19.0 | 4.5 |
| | 8-6 | 300 | 337 | 265 | 0.79 | 20.0 | 7.7 |
| | 8-7 | Extruded pipe | 295 | 212 | 0.72 | 9.0 | 20.5 |

As clearly understood from Tables 7 and 8, for both the ZK40 and ZK60 alloys, the specimens No. 7-3 through 7-6 and 8-3 through 8-6 subjected to heat treatment at temperatures above 150° C. after drawing, embodying the present invention, are shown to have a substantially improved elongation after fracture and strength, as compared with those extruded pipes which were subjected to neither drawing nor heat treatment (specimens No. 7-7 and 8-7 representing comparative examples). Specifically, these specimens No. 7-3 through 7-6 and 8-3 through 8-6 have tensile strengths above 300 MPa, 0.2% proof stress above 220 MPa, a YP ratio in the range of 0.75 to less than 0.90 and an elongation above 12%, showing improvements in ductility and strength in balance. Especially, it turns out that the specimens No. 7-4 through 7-6 and 8-4 through 8-6 for which the heat treatment was carried out at temperatures above 200° C. are further improved in toughness with their elongations higher than 18%. Among those, the specimens No. 7-4, 7-5 and 8-4, 8-5 involving a heat treatment temperature in the range of 200° C.-250° C. had tensile strength above 340 MPa, 0.2% proof stress above 250 MPa, a YP ratio in the range of 0.80 to less than 0.90 and an elongation above 18%, showing improvements in strength and ductility further in balance.

Further, it is shown that as compared with the specimens No. 7-2 and 8-2 heat-treated at 100° C. after drawing and with the specimens No. 7-1 and 8-1 not subjected to heat treatment after drawing, the specimens No. 7-3 through 7-6 and 8-3 through 8-6 which underwent heat treatment at temperatures above 150° C. after drawing are greatly improved in their elongation, although their tensile strength, 0.2% proof stress and YP ratio are somewhat reduced. On the other hand, since the rate of increase in tensile strength decreases if the heat treatment temperature exceeds 300° C., it is preferred that the heat treatment is performed at a temperature of 300° C. or below. Thus, it turns out that by executing the heat treatment at a temperature in the range of 150° C. to 300° C. (preferably 200° C. to 300° C.) after a drawing, magnesium base alloy pipes can have high strength as well as improved toughness.

Regarding the average grain size of the specimens obtained in the experiment, the extruded pipe specimens not subjected to drawing (specimens No. 7-7 and 8-7) and the specimens heat-treated at temperatures of 100° C. or below (specimens No. 7-1,7-2 and 8-1,8-2) have a larger grain size above 15 μm, as shown in Tables 7 and 8. On the other hand, the specimens heat-treated at temperatures above 200° C. (specimens No. 7-4 through 7-6 and 8-4 through 8-6) have fine grains with an average grain size of 10 μm or below. Among those, the specimens heat-treated at a temperature of 200-250° C. (specimens No. 7-4, 7-5 and 8-4, 8-5) have an average grain size of 5 μm or below. Further, the specimens heat-treated at 150° C. (specimens No. 7-3 and 8-3) had a mixed texture comprising grains having a 3 μm or smaller average grain size and grains having a 15 μm or larger average grain size, in which the grains area share by 3 μm or smaller grains was above 10%. Thus, it turns out that an alloy texture comprising fine grains or a mixed texture having fine grains and coarse grains yields a magnesium base alloy pipe having strength and toughness in balance as above.

For those specimens subjected to heat treatment (specimens No. 7-3 through 7-6 and 8-3 through 8-6) at 150° C.-300° C., it was possible to apply drawing in two more multiple passes. These specimens No. 7-3 through 7-6 and 8-3 through 8-6 had surface roughness Rz of 5 μm or below. Further, these specimens had an axial residual tensile stress of 80 MPa or below in their pipe surfaces as determined by X-ray diffraction. Besides, these pipe specimens had a differential outside diameter (difference between the largest and the smallest outside diameters in a cross section of the pipe) of 0.02 mm or below.

### EXPERIMENTAL EXAMPLE 1-7

An extruded pipe (outside diameter: 15.0 mm, wall thickness: 1.5 mm) of an ZK 40 alloy and an extruded pipe of an ZK60 alloy having the same configuration as above were drawn, respectively, at varied temperatures to be reduced in outside diameter to 12.0 mm, thus yielding various specimens of drawn magnesium base alloy pipes. The ZK40 alloy of the extruded pipe used was a magnesium base alloy containing 4.1 mass % of Zn and 0.5 mass % of Zr with the balance composed of Mg as a base material and unavoidable impurities, while the ZK60 alloy of the extruded pipe was a magnesium base alloy containing 5.5 mass % of Zn and 0.5 mass % of Zr with the balance likewise comprising Mg and unavoidable impurities. The drawing was accomplished in two passes of plain drawing, with the first pass reducing the outside diameter to 13.5 mm and the second pass reducing the same to 12.0 mm. The first and the second passes yielded area reduction ratios of 10.0% and 12.3%, respectively, with the total area reduction ratio of 21.0%. After drawing, the pipes were air-cooled at a rate of 1-5° C./sec. For heating the pipes in drawing, a heater was provided before a die, and the working temperature (drawing temperature) was observed in terms of the heating temperature set on the heater. This applies also in an experimental example 1-8 to be described herein later. The heating rate to the drawing temperature was in the range of 1-2° C./sec., and the drawing speed was 10 m/min. The resultant drawn pipes had the properties as shown in Table 9.

TABLE 9

| | | | | | Elon- | | |
|---|---|---|---|---|---|---|---|
| | | Work- | Area | | gation | 0.2% | |
| | Speci- | ing | reduction | Tensile | after | proof | |
| Alloy | men | temp. | ratio | strength | fracture | stress | YP |
| type | No. | (° C.) | (%) | (MPa) | (%) | (MPa) | ratio |
| ZK40 | 9-1 | Not worked | | 275 | 8.0 | 201 | 0.73 |
| | | (extruded pipe) | | | | | |
| | 9-2 | 20 | 21 | Working impossible | | | |
| | 9-3 | 50 | 21 | 448 | 6.0 | 419 | 0.94 |
| | 9-4 | 100 | 21 | 432 | 9.0 | 405 | 0.94 |
| | 9-5 | 200 | 21 | 421 | 10.0 | 389 | 0.92 |
| | 9-6 | 300 | 21 | 395 | 11.5 | 362 | 0.92 |
| ZK60 | 9-7 | Not worked | | 295 | 9.0 | 212 | 0.72 |
| | | (extruded pipe) | | | | | |
| | 9-8 | 20 | 21 | Working impossible | | | |
| | 9-9 | 50 | 21 | 477 | 6.0 | 446 | 0.94 |
| | 9-10 | 100 | 21 | 464 | 9.0 | 435 | 0.94 |
| | 9-11 | 200 | 21 | 452 | 10.0 | 419 | 0.93 |
| | 9-12 | 300 | 21 | 426 | 10.5 | 392 | 0.92 |

tensile strength below 300 MPa, 0.2% proof stress below 220 MPa, a YP ratio below 0.75, and an elongation (elongation after fracture) of 8-9%. While, the drawn pipe specimens No. 9-3 through 9-6 and the specimens 9-9 through 9-12 drawn at temperatures above 50° C., embodying the present invention, have tensile strength above 300 MPa, 0.2% proof stress above 250 MPa, a YP ratio above 0.90 in addition to an elongation duly above 5%. Thus, it will be clearly understood that the specimens prepared according to the present invention are improved in their strength without greatly reducing its toughness. Among those last specimens, the No. 9-4 through 9-6 specimens and No. 9-10 through 9-12 specimens which were drawn at temperatures from 100° C. to 300° C. are improved particularly in toughness with their further higher elongations above 8%. Therefore, it will be understood that the drawing temperature is preferably in the range of 100° C. to 300° C. in view of elongation after fracture. When the drawing temperature exceeded 300° C. the rate of increase in tensile strength became low, while the specimens No. 9-2 and 9-8 subjected to drawing at a room temperature, namely 20° C., representing another comparative examples, could not actually withstand working due to breakage. Thus, it turns out that the balance of strength and toughness is more improved by employing a drawing temperature in the range of 50° C. to 300° C. (preferably 100° C. to 300° C.).

For the resultant specimens No. 9-3 through 9-6 and 9-9 through 9-12, it was possible to apply drawing even in 3 or more passes. These specimens No. 9-3 through 9-6 and 9-9 through 9-12 had surface roughness Rz of 5 μm or below and an axial residual tensile stress of 80 MPa or below in their pipe surfaces as determined by X-ray diffraction. Besides, these pipe specimens had a differential outside diameter (difference between the largest and the smallest outside diameters in a cross section of the pipe) of 0.02 mm or below.

### EXPERIMENTAL EXAMPLE 1-8

An extruded pipe (outside diameter: 15.0 mm, wall thickness: 1.5 mm) of an ZK40 alloy and an extruded pipe of an ZK60 alloy having the same configuration as above were drawn, respectively, with varied reduction ratios, thus yielding various specimens of drawn magnesium base alloy pipes having different outside diameters. The ZK40 alloy of the extruded pipe used was a magnesium base alloy containing 4.1 mass % of Zn and 0.5 mass % of Zr with the balance composed of Mg as a base material and unavoidable impurities, while the ZK60 alloy of the extruded pipe was a magnesium base alloy containing 5.5 mass % of Zn and 0.5 mass % of Zr with the balance likewise comprising Mg and unavoidable impurities. The drawing was accomplished in one pass of plain drawing by using varied area reduction ratios of 5.5% (O.D. after a drawing: 14.20 mm), 10.0% (O.D. after a drawing: 13.5 mm) and 21.0% (O.D. after a drawing: 12.0 mm), respectively. The drawing temperature was 150° C., and the cooling rate after drawing was 1-5° C./sec. The heating rate to the drawing temperature was in the range of 1-2° C./sec., and the drawing speed was 10 m/min. The resultant drawn pipes had the properties as shown in Table 10.

TABLE 10

| | | | | | Elon- | | |
|---|---|---|---|---|---|---|---|
| | | Work- | Area | | gation | 0.2% | |
| | Speci- | ing | reduction | Tensile | after | proof | |
| Alloy | men | temp. | ratio | strength | fracture | stress | YP |
| type | No. | (° C.) | (%) | (MPa) | (%) | (MPa) | ration |
| ZK40 | 10-1 | Not worked | | 275 | 8.0 | 201 | 0.73 |
| | | (extruded pipe) | | | | | |
| | 10-2 | 150 | 5.5 | 339 | 10.5 | 306 | 0.90 |
| | 10-3 | 150 | 10 | 378 | 10.0 | 348 | 0.92 |
| | 10-4 | 150 | 21 | 425 | 8.5 | 399 | 0.94 |
| ZK60 | 10-5 | Not worked | | 295 | 9.0 | 212 | 0.72 |
| | | (extruded pipe) | | | | | |
| | 0-6 | 150 | 5.5 | 377 | 10.5 | 342 | 0.91 |
| | 10-7 | 150 | 10 | 421 | 9.5 | 389 | 0.92 |
| | 10-8 | 150 | 21 | 458 | 9.5 | 431 | 0.94 |

As shown in Table 10, the extruded pipes (specimens No. 10-1 and 10-5 representing comparative examples) of ZK40 and ZK60 alloys, respectively, have tensile strength below 300 MPa, 0.2% proof stress below 220 MPa, a YP ratio below 0.75, and an elongation of 8-9%. While, the drawn pipe specimens No. 10-2 through 10-4 and the specimens 10-6 through 10-8 drawn with an area reduction ratio above 5%, embodying the present invention, have tensile strength above 300 MPa, 0.2% proof stress above 250 MPa, a YP ratio above 0.90 in addition to a high elongation above 8%. Thus, it will be clearly understood that by drawing with an area reduction ratio above 5% the specimens prepared according to the present invention are improved in their strength without greatly reducing its toughness.

These specimens No. 10-2 through 10-4 and 10-6 through 10-8 had surface roughness Rz of 5 μm or below and an axial residual tensile stress of 80 MPa or below in their pipe surfaces as determined by X-ray diffraction. Besides, these pipe specimens had a differential outside diameter of 0.02 mm or below.

### EXPERIMENTAL EXAMPLE 1-9

An extruded pipe (outside diameter: 15.0 mm, wall thickness: 1.5 mm) of a magnesium base alloy (AM60 alloy) containing 6.1 mass % of Al and 0.44 mass % of Mn with the balance composed of Mg as a base material and unavoidable impurities was drawn at 150° C. to be reduced in outside diameter to 12.0 mm to prepare drawn magnesium base alloy pipe specimen. The drawing was performed in the same manner and under the same conditions as in the experimental example 1-1 above, except that the drawing temperature was fixed at 150° C. As comparative examples, a specimen was prepared by drawing the extruded pipe in the same manner as above at 20° C. In this experiment, the resultant drawn pipes had the properties as shown in Table 11.

TABLE 11

| | | | Area | | | | |
|---|---|---|---|---|---|---|---|
| | | Working | reduction | Tensile | Elongation | 0.2% proof | |
| Alloy | Specimen | temp. | ratio | strength | after fracture | stress | |
| type | No. | (° C.) | (%) | (MPa) | (%) | (MPa) | YP ratio |
| AM60 | 11-1 | Not worked | | 267 | 8.5 | 165 | 0.62 |
| | | (extruded pipe) | | | | | |
| | 11-2 | 20 | 21 | Working impossible | | | |
| | 11-3 | 150 | 21 | 375 | 8.0 | 348 | 0.93 |

As shown in Table 11, the extruded pipe not subjected to drawing (specimen No. 11-1) had tensile strength of 267 MPa, 0.2% proof stress of 165 MPa, YP ratio of 0.62 and elongation after fracture of 8.5%. While, the drawn pipe specimen No. 11-3 drawn with an area reduction ratio above 5%, embodying the present invention, have tensile strength above 300 MPa, 0.2% proof stress above 250 MPa, a YP ratio above 0.90 in addition to a high elongation above 8%. Thus, it will be clearly understood that the specimen prepared according to the present invention is improved in its strength without greatly reducing its toughness. This specimen had surface roughness Rz of 5 μm or below and an axial residual tensile stress of 80 MPa or below in their pipe surfaces as determined by X-ray diffraction. Besides, these pipe specimens had a differential outside diameter of 0.02 mm.

### EXPERIMENTAL EXAMPLE 1-10

An extruded pipe (outside diameter 15.0 mm, wall thickness of 1.5 mm) of a magnesium base alloy (AM60) containing 6.1 mass % of Al and 0.44 mass % of Mn with the balance composed of Mg as a base material and unavoidable impurities was drawn at 150° C. to be reduced in outside diameter to 12.0 mm, and then the drawn pipes were subjected to heat treatment at 200° C. to prepare a drawn magnesium base alloy pipe specimen. The pipe specimens were prepared in the same manner and under the same conditions as in the experimental example 1-1 above, except that the drawing temperature was fixed at 150° C. and a 200° C. heat treatment was applied after drawing. As comparative examples, were prepared in the same manner as above a specimen which was heat-treated at 100° C. after drawing and a specimen not subjected to heat treatment. Further, the resultant pipe specimens were studied for their average grain size in the same manner as in the experimental example 1-4 above. These resultant pipe specimens had the properties as shown in Table 12.

TABLE 12

| | | Heat treatment | Tensile | 0.2% proof | | Elongation | Average |
|---|---|---|---|---|---|---|---|
| Alloy | Specimen | temp. | strength | stress | | after fracture | grain size |
| type | No. | (° C.) | (MPa) | (MPa) | YP ratio | (%) | (μm) |
| AM60 | 12-1 | Without | 375 | 348 | 0.93 | 8.0 | 18.2 |
| | 12-2 | 100 | 372 | 344 | 0.92 | 8.0 | 18.5 |
| | 12-3 | 200 | 330 | 285 | 0.86 | 18.0 | 3.8 |
| | 12-4 | Extruded pipe | 267 | 165 | 0.62 | 8.5 | 18.5 |

have a substantially improved elongation after fracture and strength, as compared with the extruded pipe which was subjected to neither drawing nor heat treatment (specimen No. 12-4 a representing comparative example). Further, regarding the average grain size of the specimens prepared in the experiment, the extruded pipe specimen not subjected to drawing (specimens No. 12-4), the drawn specimen not subjected to heat treatment (specimen No. 12-1) and the specimen heat-treated at 100° C. (specimens No. 12-2) have a larger grain size above 15 μm. On the other hand, the specimen heat-treated at temperatures at 200° C. (specimen No. 12-3) has fine grains with an average grain size below 5 μm. This specimen No. 12-3 had surface roughness Rz below 5 μm and an axial residual tensile stress below 80 MPa in their pipe surfaces as determined by X-ray diffraction. Besides, the No. 12-3 had a differential outside diameter below 0.02 mm.

### EXPERIMENTAL EXAMPLE 2-1

Extruded pipe blanks (O.D.: 10-45 mm, wall thickness: 1.0-5 mm) of an Az31 alloy and an AZ61 alloy were pointed, respectively, with different working ratios at varied temperatures. The AZ31 alloy of the extruded pipes used was a magnesium base alloy containing 2.9 mass % of Al, 0.77 mass % of Zn and 0.40 mass % of Mn with the balance composed of Mg as a base material and unavoidable impurities, while the AZ61 alloy of the extruded pipes was a magnesium base alloy containing 6.4 mass % of Al, 0.77 mass % of Zn and 0.35 mass % of Mn with the balance likewise comprising Mg and unavoidable impurities.

For the pointing operation, a front end of a pipe blank was heated at 350° C. and the time elapsing before the front end was fed in a die of a swaging machine thereafter (cooling time) was varied to control the temperature of the pipe blank at its front working end just before it was fed in a swaging machine (inlet temperature). The inlet temperature was determined by calculation from the heating temperature (350° C.) and the cooling time. For heating some pipe blanks, the die of the swaging machine was also heated. The die was heated at 150° C. Further, some pipe blanks were heated with a cylindrical copper block (heat insulating material) inserted in their front ends. For each pipe blank, the inlet temperature, use of die heating, use of a heat insulating material, and the workability at each working ratio are shown in Tables 13 and 14. The working ratio is given by {(pipe O.D. before working−pipe O.D. after working)/pipe O.D. before working}×100, and the workability is marked with “o” for specimens worked without cracking, while it is marked with “x” for specimens that underwent cracking. The pointed specimens exhibited a certain relationship between the outside diameters of pipes before working and their working ratios, as shown on the graphs of

TABLE 13

| | | | | Heat | Workability vs. | | | |
|---|---|---|---|---|---|---|---|---|
| Specimen | | Inlet temp. | Die | insulating | working ratio | | | |
| No. | Alloy type | (° C.) | heating | material | 3% | 5% | 10% | Notes |
| 13-1 | AZ31 | 20 | No | No | X | X | X | |
| 13-2 | AZ31 | 50 | No | No | ◯ | X | X | |
| 13-3 | AZ31 | 100 | No | No | ◯ | ◯ | ◯ | |
| 13-4 | AZ31 | 450 | No | No | ◯ | ◯ | ◯ | |
| 13-5 | AZ31 | 480 | No | No | ◯ | ◯ | ◯ | *1 |
| 13-6 | AZ31 | 20 | Yes | No | ◯ | X | X | |
| 13-7 | AZ31 | 50 | Yes | No | ◯ | ◯ | X | |
| 13-8 | AZ31 | 100 | Yes | No | ◯ | ◯ | ◯ | |
| 13-9 | AZ31 | 450 | Yes | No | ◯ | ◯ | ◯ | |
| 13-10 | AZ31 | 480 | Yes | No | ◯ | ◯ | ◯ | *1 |
| 13-11 | AZ31 | 20 | No | Yes | X | X | X | |
| 13-12 | AZ31 | 50 | No | Yes | ◯ | ◯ | X | |
| 13-13 | AZ31 | 100 | No | Yes | ◯ | ◯ | ◯ | |
| 13-14 | AZ31 | 450 | No | Yes | ◯ | ◯ | ◯ | |
| 13-15 | AZ31 | 480 | No | Yes | ◯ | ◯ | ◯ | *1 |

*1: Unusable due to severe surface oxidation

TABLE 14

| | | | | Heat | Workability vs. | | | |
|---|---|---|---|---|---|---|---|---|
| Specimen | | Inlet temp. | Die | insulating | working ratio | | | |
| No. | Alloy type | (° C.) | heating | material | 2% | 3% | 5% | Notes |
| 14-1 | AZ61 | 20 | No | No | X | X | X | |
| 14-2 | AZ61 | 50 | No | No | ◯ | X | X | |
| 14-3 | AZ61 | 100 | No | No | ◯ | ◯ | ◯ | |
| 14-4 | AZ61 | 450 | No | No | ◯ | ◯ | ◯ | |
| 14-5 | AZ61 | 480 | No | No | ◯ | ◯ | ◯ | *1 |
| 14-6 | AZ61 | 20 | Yes | No | ◯ | X | X | |
| 14-7 | AZ61 | 50 | Yes | No | ◯ | ◯ | X | |
| 14-8 | AZ61 | 100 | Yes | No | ◯ | ◯ | ◯ | |
| 14-9 | AZ61 | 450 | Yes | No | ◯ | ◯ | ◯ | |
| 14-10 | AZ61 | 480 | Yes | No | ◯ | ◯ | ◯ | *1 |
| 14-11 | AZ61 | 20 | No | Yes | X | X | X | |
| 14-12 | AZ61 | 50 | No | Yes | ◯ | ◯ | X | |
| 14-13 | AZ61 | 100 | No | Yes | ◯ | ◯ | ◯ | |
| 14-14 | AZ61 | 450 | No | Yes | ◯ | ◯ | ◯ | |
| 14-15 | AZ61 | 480 | No | Yes | ◯ | ◯ | ◯ | *1 |

*1: Unusable due to severe surface oxidation

specimens having a 50° C. inlet temperature can be pointed with a higher working ratio, if either the die heating or the heat insulating material is combined therewith. Further, those specimens involving an inlet temperature of 100-450° C. allow pointing with a high working ratio above 5%. Although the specimens involving an inlet temperature above 480° C. could be pointed, it was determined that such specimens could not bear commercial applications due to their remarkable surface oxidation. Besides, it was shown that according to the method of the present invention a magnesium base alloy pipe having a wall thickness of 0.5 mm may be produced.

### EXPERIMENTAL EXAMPLE 2-2

In this experiment, pipe blanks were prepared by providing a film coating on extruded pipes of alloys having the same chemical compositions as those used in the experimental example 2-1 above. The film coating was accomplished by first dispersing a PTFE resin in water to prepare its aqueous dispersion liquid, then immersing a pipe blank in this dispersion liquid, and subsequently heating the wet pipe blank at 400° C. to form PTFE coating on the pipe surface. Thereafter, the thus coated pipe blank was pointed in the same manner as in the specimen No. 13-3 in the experimental example 2-1 and then subjected to drawing.

Using a drawbench, the drawing was carried out by plug drawing in one pass. The pipe blanks were subjected to drawing along with their heating by any appropriate means including immersion in a preheated lubricant, an atmosphere furnace, a high-frequency heating furnace or drawing die heating. The exit temperature of the pipe blank was adjusted by varying the time elapsing before it was fed in the drawing die after it was taken out from a lubricant bath, an atmosphere furnace or a high-frequency furnace. The exit temperature is a temperature of the drawn pipe just behind the exit of the drawing die. The heating rate to exit temperature was 1-2° C./sec. After drawing, the pipes were air-cooled at a rate of 1-5° C./sec. The drawing speed was 10 m/min.

The exit temperature, heating method, lubrication method, and the workability at each working ratio for the AZ31 and AZ61 specimens are shown in Tables 15 and Table 16, respectively. The working ratio is given by {(pipe cross-sectional area before working−pipe cross-sectional area after working)/pipe cross-sectional area before working}×100. The workability is marked with “o” for specimens worked without cracking, while it is marked with “x” for specimens that underwent cracking and with “seized” for specimens undergoing seizing. In the “lubrication method” column of Tables 15 and 16, “oil” indicates application of a lubricating oil to a pipe blank, with “film coating+oil” indicating application of a lubricating oil to a PTFE resin-coated pipe blank, “film coating” indicating that a PTFE resin-coated pipe blank is drawn without using a lubricating oil, and “forced lubrication” indicating that drawing is done by forcedly supplying a lubricating oil into a gap between a die and the pipe blank.

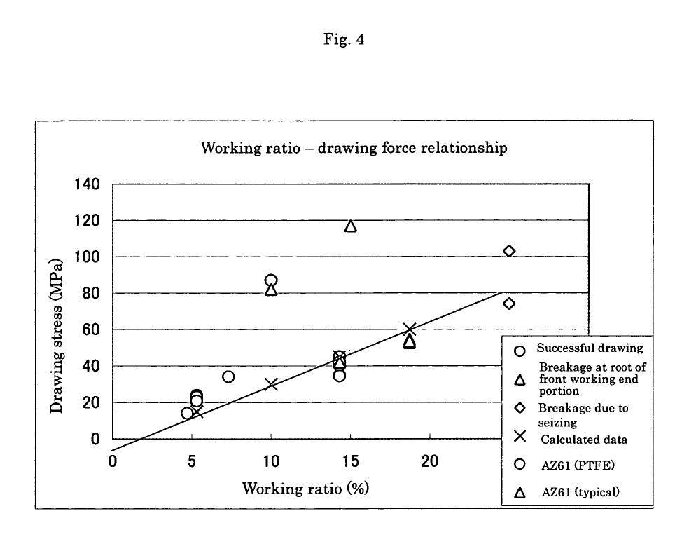

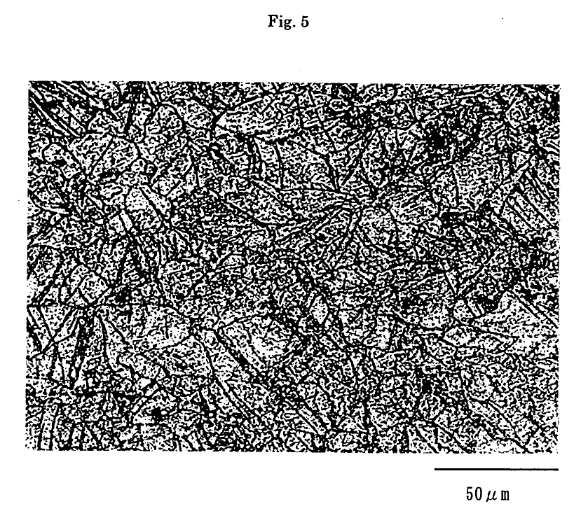

Further, for the drawing process, a relationship between the working ratio and the drawing force was studied. The drawing force was measured by means of a load cell provided on the exit side of the drawing die. The observed relationship between the working ratio and the drawing force is shown on the graph of FIG. 4. In the graph of FIG. 4, the white circle, triangle and diamond represent data for AZ31 specimens, with Az61 (PTFE) (black circle) representing data for film-coated AZ61 specimens immersed in a lubricant, and AZ61(typical) (black triangle) representing data for AZ61 specimens that were merely immersed in lubricant without film coating, while “x”mark indicating calculated data.

TABLE 15

| | | Exit | | | Workability vs. | | |
|---|---|---|---|---|---|---|---|
| Specimen | Alloy | temp. | | | working ratio | | |
| No. | type | (° C.) | Heating method | Lubrication method | 5% | 10% | 20% |
| 5-1 | AZ31 | 20 | Immersed in lubricant | Oil | ◯ | X | X |
| 15-2 | AZ31 | 50 | Immersed in lubricant | Oil | ◯ | ◯ | X |
| 15-3 | AZ31 | 100 | Immersed in lubricant | Oil | ◯ | ◯ | ◯ |
| 15-4 | AZ31 | 200 | Immersed in lubricant | Oil | ◯ | ◯ | ◯ |
| 15-5 | AZ31 | 250 | Immersed in lubricant | Oil | ◯ | ◯ | X |
| 15-6 | AZ31 | 20 | Immersed in lubricant | Film coating + oil | ◯ | X | X |
| 15-7 | AZ31 | 50 | Immersed in lubricant | Film coating + oil | ◯ | ◯ | X |
| 15-8 | AZ31 | 100 | Immersed in lubricant | Film coating + oil | ◯ | ◯ | ◯ |
| 15-9 | AZ31 | 200 | Immersed in lubricant | Film coating + oil | ◯ | ◯ | ◯ |
| 15-10 | AZ31 | 250 | Immersed in lubricant | Film coating + oil | ◯ | ◯ | X |
| 15-11 | AZ31 | 200 | Atmosphere furnace | Forced lubrication | ◯ | ◯ | ◯ |
| 15-12 | AZ31 | 200 | Atmosphere furnace | Film coating + oil | ◯ | ◯ | ◯ |
| 15-13 | AZ31 | 300 | Atmosphere furnace | Film coating | ◯ | ◯ | X |
| 15-14 | AZ31 | 200 | High-frequency furnace | Forced lubrication | ◯ | ◯ | ◯ |
| 15-15 | AZ31 | 200 | High-frequency furnace | Film coating + oil | ◯ | ◯ | ◯ |
| 15-16 | AZ31 | 300 | High-frequency furnace | Film coating | ◯ | ◯ | X |
| 15-17 | AZ31 | 100 | Die heating | Forced lubrication | ◯ | ◯ | ◯ |
| 15-18 | AZ31 | 100 | Die heating | Film coating + oil | ◯ | ◯ | ◯ |
| 15-19 | AZ31 | 300 | Die heating | Film coating | ◯ | ◯ | X |

TABLE 16

| | | Exit | | | Workability vs. | | |
|---|---|---|---|---|---|---|---|
| Specimen | | temp. | | | working ratio | | |
| No. | Alloy type | (° C.) | Heating method | Lubrication method | 5% | 10% | 20% |
| 16-1 | AZ61 | 20 | Immersed in lubricant | Oil | ◯ | X | X |
| 16-2 | AZ61 | 50 | Immersed in lubricant | Oil | ◯ | Seized | X |
| 16-3 | AZ61 | 100 | Immersed in lubricant | Oil | ◯ | Seized | Seized |
| 16-4 | AZ61 | 200 | Immersed in lubricant | Oil | ◯ | Seized | Seized |
| 16-5 | AZ61 | 250 | Immersed in lubricant | Oil | ◯ | Seized | Seized |
| 16-6 | AZ61 | 20 | Immersed in lubricant | Film coating + oil | ◯ | X | X |
| 16-7 | AZ61 | 50 | Immersed in lubricant | Film coating + oil | ◯ | ◯ | X |
| 16-8 | AZ61 | 100 | Immersed in lubricant | Film coating + oil | ◯ | ◯ | ◯ |
| 16-9 | AZ61 | 200 | Immersed in lubricant | Film coating + oil | ◯ | ◯ | ◯ |
| 16-10 | AZ61 | 250 | Immersed in lubricant | Film coating + oil | ◯ | ◯ | X |
| 16-11 | AZ61 | 200 | Atmosphere furnace | Forced lubrication | ◯ | Seized | Seized |
| 16-12 | AZ61 | 200 | Atmosphere furnace | Film coating + oil | ◯ | ◯ | ◯ |
| 16-13 | AZ61 | 300 | Atmosphere furnace | Film coating | ◯ | ◯ | X |
| 16-14 | AZ61 | 200 | High-frequency furnace | Forced lubrication | ◯ | Seized | Seized |
| 16-15 | AZ61 | 200 | High-frequency furnace | Film coating + oil | ◯ | ◯ | ◯ |
| 16-16 | AZ61 | 300 | High-frequency furnace | Film coating | ◯ | ◯ | X |
| 16-17 | AZ61 | 100 | Die heating | Forced lubrication | ◯ | Seized | Seized |
| 16-18 | AZ61 | 100 | Die heating | Film coating + oil | ◯ | ◯ | ◯ |
| 16-19 | AZ61 | 300 | Die heating | Film coating | ◯ | ◯ | X |

From Tables 15, 16 and the graph of FIGS. 4, it turns out that desirable results were obtained at exit temperatures ranging from 50 to 300° C. Especially, it is understood that the specimens combining the film coating and the lubrication by lubricating oil can be subjected to drawing with a higher working ratio.

### EXPERIMENTAL EXAMPLE 2-3

In this experimental example, some extruded pipes used in the experimental example 2-2 above were subjected to drawing in multiple passes so as to effect a varied total working ratio, and some of the drawn pipes were heat-treated after drawing. The “heating method” for drawing was the immersion in a preheated lubricant, and the “lubrication method” is accomplished using a lubricating oil. For drawing, the specimens with a 15% total working ratio were drawn in one pass, the specimens with a 30% total working ratio were drawn in two passes, while those with a 45% total working ratio were worked in three passes. For each pass, the pipe blank was immersed in the lubricating oil to be heated to an exit temperature. The total working ratio is given by {(pipe cross-sectional area before working−pipe cross-sectional area after the last working)/pipe cross-sectional area before working}×100. The heat treatment after drawing was applied at 250° C. for 30 minutes. The elongation and the tensile strength were measured on all the resultant drawn pipe specimens. The exit temperature, total working ratio, use of heat treatment after drawing, elongation and tensile strength are shown in Table 17 for the respective specimens.

TABLE 17

| | | | Total working | | Elongation | |
|---|---|---|---|---|---|---|
| Specimen | | Exit temp. | ratio | Heat treatment | after fracture | Tensile strength |
| No. | Alloy type | (° C.) | (%) | after drawing | (%) | (MPa) |
| 17-1 | AZ31 | 200 | 15 | No | 3 | 280 |
| 17-2 | AZ31 | 200 | 30 | No | 4 | 320 |
| 17-3 | AZ31 | 200 | 45 | No | 3 | 370 |
| 17-4 | AZ31 | 200 | 45 | Yes | 20 | 280 |
| 17-5 | AZ61 | 200 | 15 | No | 3 | 300 |
| 17-6 | AZ61 | 200 | 30 | No | 2 | 340 |
| 17-7 | AZ61 | 200 | 45 | No | 4 | 380 |
| 17-8 | AZ61 | 200 | 45 | Yes | 15 | 330 |

exhibited a very unique structure in which twins and recrystallized grains were contained mixedly.

### EXPERIMENTAL EXAMPLE 2-4

In this experimental example, bending was applied using the same specimen No. 15-4 as fabricated in the experimental example 2-2. By a rotating bending method, bending was imparted to the drawn pipe specimen of 21.5 mm in outside diameter D and 1 mm in wall thickness at room temperatures to cause its bend of 2.8 D in radius of curvature. As a result, it was shown that the magnesium base alloy pipe prepared according to the present invention can be bent well in such a small bending radius.

### EXPERIMENTAL EXAMPLE 2-5

An extruded pipe of an Az31 alloy was fabricated into a butted pipe in the following way. First, the starting extruded pipe of 28 mm in O.D. and 2.5 mm in wall thickness was drawn by plug drawing into a pipe of 24 mm in O.D. and 2.2 mm in wall thickness. Then, the drawn pipe was heat-treated at 250° C. for 30 minutes after drawing. For this drawing, pointing was done under the same conditions as for the specimen No. 13-3 in the experimental example 2-1 above, and the pointed pipe was drawn under the same conditions as for the specimen No. 15-4 in the experimental example 2-2 above. This applies likewise in the plain drawing and the plug drawing to be described below.

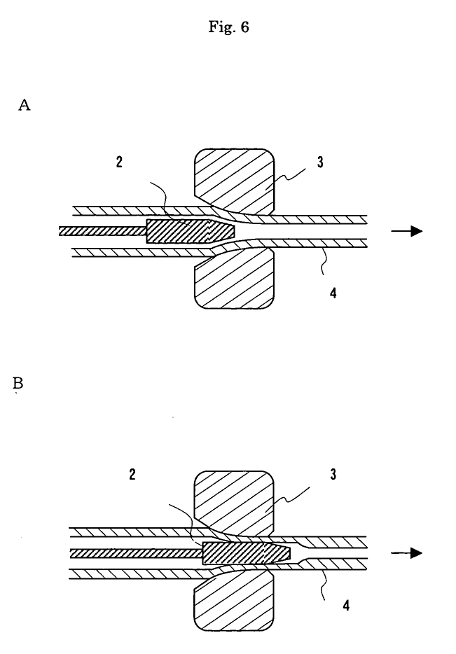

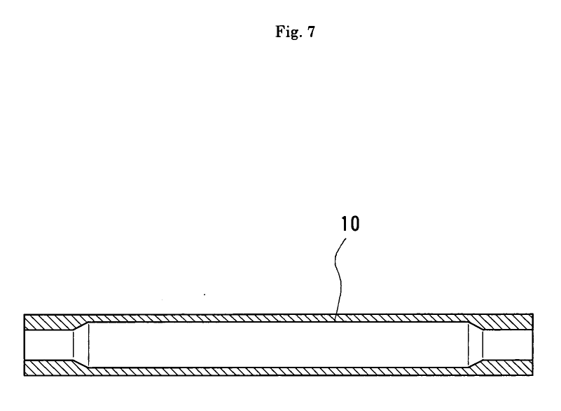

Using the resultant drawn pipe, a butted pipe was fabricated by combining the plain drawing and the plug drawing, as illustrated in FIG. 6. First, one end of a drawn pipe 4 was passed through a die 3, and then the drawn pipe 4 was subjected to plain drawing without squeezing its wall between the plug 2 and the inside of the die 3 (FIG. 6A). Thereafter, the middle portion of the drawn pipe 4 was subjected to plug drawing, in which the drawn pipe 4 had its wall squeezed between the inside of the die 3 and the plug 2 reaching the inside of the die 3 (FIG. 6B). Then, the plug 2 was retracted, and the other end of the drawn pipe 4 was subjected also to plain drawing without squeezing the wall of the drawn pipe 4 between the plug 2 and the inside of the die 3 (FIG. 6A). By this process, a butted pipe 10 having thick-walled opposite end portions and a thin-walled intermediate portion could be formed, as shown in FIG. 7. The resultant butted pipe 10 was 23 mm in O.D., 2.3 mm in wall thickness at its opposite ends and 2.0 mm in wall thickness at its middle portion.

### EXPERIMENTAL EXAMPLE 3-1

Extruded pipe blanks (O.D.: 10-45 mm, wall thickness: 1.0-5 mm) of an ZK60 alloy was pointed with different working ratios at varied temperatures in the same manner as in the experimental example 2-1. The ZK60 alloy of the extruded pipe was a magnesium base alloy containing 5.9 mass % of Zn and 0.70 mass % of Zr with the balance comprising Mg and unavoidable impurities.

For the pointing operation, a front end of a pipe blank was heated at 350° C. and the time elapsing before the front end was fed in a die of a swaging machine thereafter (cooling time) was varied to control the temperature of the pipe blank at its front working end just before it was fed in a swaging machine (inlet temperature). The inlet temperature was determined by calculation from the heating temperature (350° C.) and the cooling time. For heating some pipe blanks, the die of the swaging machine was also heated. The die was heated at 150° C. Further, some pipe blanks were heated with a cylindrical copper block (heat insulating material) inserted in their front ends. For each pipe blank, the inlet temperature, use of die heating, use of a heat insulating material, and the workability at each working ratio are shown in, Table 18. The working ratio is given by {(pipe O.D. before working−pipe O.D. after working)/pipe O.D. before working}×100, and the workability is marked with “o” for specimens worked without cracking, while it is marked with “x” for specimens that underwent cracking.

TABLE 18

| | | | | Heat | Workability vs. | | | |
|---|---|---|---|---|---|---|---|---|
| Specimen | | Inlet temp. | Die | insulating | working ratio | | | |
| No. | Alloy type | (° C.) | heating | material | 3% | 5% | 10% | Notes |
| 18-1 | ZK60 | 20 | No | No | X | X | X | |
| 18-2 | ZK60 | 50 | No | No | ◯ | X | X | |
| 18-3 | ZK60 | 100 | No | No | ◯ | ◯ | ◯ | |
| 18-4 | ZK60 | 450 | No | No | ◯ | ◯ | ◯ | |
| 18-5 | ZK60 | 480 | No | No | ◯ | ◯ | ◯ | ※1 |
| 18-6 | ZK60 | 20 | Yes | No | ◯ | X | X | |
| 18-7 | ZK60 | 50 | Yes | No | ◯ | ◯ | X | |
| 18-8 | ZK60 | 100 | Yes | No | ◯ | ◯ | ◯ | |
| 18-9 | ZK60 | 450 | Yes | No | ◯ | ◯ | ◯ | |
| 18-10 | ZK60 | 480 | Yes | No | ◯ | ◯ | ◯ | ※1 |
| 18-11 | ZK60 | 20 | No | Yes | X | X | X | |
| 18-12 | ZK60 | 50 | No | Yes | ◯ | ◯ | X | |
| 18-13 | ZK60 | 100 | No | Yes | ◯ | ◯ | ◯ | |
| 18-14 | ZK60 | 450 | No | Yes | ◯ | ◯ | ◯ | |
| 18-15 | ZK60 | 480 | No | Yes | ◯ | ◯ | ◯ | ※1 |

*1: Unusable due to severe surface oxidation

working ratios are in the rage of about 2-3%. The specimens having a 50° C. inlet temperature can be pointed with a higher working ratio, if either the die heating or the heat insulating material is combined therewith. Further, those specimens involving an inlet temperature of 100-450° C. allow pointing with a high working ratio above 5%. Although the specimens involving an inlet temperature above 480° C. could be pointed, it was determined that such specimens could not bear commercial applications due to their remarkable surface oxidation. Besides, it was shown that according to the method of the present invention a magnesium base alloy pipe having a wall thickness of 0.5 mm may be produced.

### EXPERIMENTAL EXAMPLE 3-2

In this experiment, pipe blanks were prepared by providing a film coating on extruded pipes of alloys having the same chemical compositions as those used in the experimental example 3-1 above. The film coating was accomplished by first dispersing a PTFE resin in water to prepare its aqueous dispersion liquid, then immersing a pipe blank in this dispersion liquid, and subsequently taking out and heating the wet pipe blank at 400° C. to form PTFE coating on the pipe surface. Thereafter, the thus coated pipe blank was pointed in the same manner as in the specimen No. 18-3 in the experimental example 3-1 and then subjected to drawing.

Using a drawbench, the drawing was carried out by plug drawing in one pass. The pipe blanks were subjected to drawing along with their heating by any appropriate means including immersion in a preheated lubricant, an atmosphere furnace, a high-frequency heating furnace or drawing die heating. The exit temperature of the pipe blank was adjusted by varying the time elapsing before it was fed in the drawing die after it was taken out from a lubricant bath, an atmosphere furnace or a high-frequency furnace. The exit temperature is a temperature of the drawn pipe just behind the exit of the drawing die. The heating rate to exit temperature was 1-2° C./sec. After drawing, the pipes were air-cooled at a rate of 1-5° C./sec. The drawing speed was 10 m/min.

The exit temperature, heating method, lubrication method, and the workability at each working ratio for the ZK60 specimens are shown in Table19. The working ratio is given by {(pipe cross-sectional area before working−pipe cross-sectional area after working)/pipe cross-sectional area before working}×100. The workability is marked with “o” for specimens worked without cracking, while it is marked with “x” for specimens that underwent cracking and with “seized” for specimens undergoing seizing. In the “lubrication method” column of Table 19, “oil” indicates application of a lubricating oil to a pipe blank, with “film coating+oil” indicating application of a lubricating oil to a PTFE resin-coated pipe blank, “film coating” indicating that a PTFE resin-coated pipe blank is drawn without using a lubricating oil, and “forced lubrication” indicating that drawing is done by forcedly supplying a lubricating oil into a gap between a die and the pipe blank.

TABLE 19

| | | | | | Workability vs. | | |
|---|---|---|---|---|---|---|---|
| Specimen | | Exit temp. | | | working ratio | | |
| No. | Alloy type | (° C.) | Heating method | Lubrication method | 5% | 10% | 20% |
| 19-1 | ZK60 | 20 | Immersed in lubricant | Oil | ◯ | X | X |
| 19-2 | ZK60 | 50 | Immersed in lubricant | Oil | ◯ | ◯ | X |
| 19-3 | ZK60 | 100 | Immersed in lubricant | Oil | ◯ | ◯ | ◯ |
| 19-4 | ZK60 | 200 | Immersed in lubricant | Oil | ◯ | ◯ | ◯ |
| 19-5 | ZK60 | 250 | Immersed in lubricant | Oil | ◯ | ◯ | X |
| 19-6 | ZK60 | 20 | Immersed in lubricant | Film coating + oil | ◯ | X | X |
| 19-7 | ZK60 | 50 | Immersed in lubricant | Film coating + oil | ◯ | ◯ | X |
| 19-8 | ZK60 | 100 | Immersed in lubricant | Film coating + oil | ◯ | ◯ | ◯ |
| 19-9 | ZK60 | 200 | Immersed in lubricant | Film coating + oil | ◯ | ◯ | ◯ |
| 19-10 | ZK60 | 250 | Immersed in lubricant | Film coating + oil | ◯ | ◯ | X |
| 19-11 | ZK60 | 200 | Atmosphere furnace | Forced lubrication | ◯ | ◯ | ◯ |
| 19-12 | ZK60 | 200 | Atmosphere furnace | Film coating + oil | ◯ | ◯ | ◯ |
| 19-13 | ZK60 | 300 | Atmosphere furnace | Film coating | ◯ | ◯ | X |
| 19-14 | ZK60 | 200 | High-frequency furnace | Forced lubrication | ◯ | ◯ | ◯ |
| 19-15 | ZK60 | 200 | High-frequency furnace | Film coating + oil | ◯ | ◯ | ◯ |
| 19-16 | ZK60 | 300 | High-frequency furnace | Film coating | ◯ | ◯ | X |
| 19-17 | ZK60 | 100 | Die heating | Forced lubrication | ◯ | ◯ | ◯ |
| 19-18 | ZK60 | 100 | Die heating | Film coating + oil | ◯ | ◯ | ◯ |
| 19-19 | ZK60 | 300 | Die heating | Film coating | ◯ | ◯ | X |

temperatures ranging from 50 to 300° C. Especially, it is understood that the specimens combining the film coating and the lubrication by lubricating oil can be subjected to drawing with a higher working ratio.

### EXPERIMENTAL EXAMPLE 3-3

In this experimental example, some extruded pipes used in the experimental example 3-2 above were subjected to drawing in multiple passes so as to effect a varied total working ratio, and some of the drawn pipes were heat-treated after drawing. The “heating method” for drawing was the immersion in a preheated lubricant, and the “lubrication method” is accomplished using a lubricating oil. For drawing, the specimens with a 15% total working ratio were drawn in one pass, the specimens with a 30% total working ratio were drawn in two passes, while those with a 45% total working ratio were worked in three passes. For each pass, the pipe blank was immersed in the lubricating oil to be heated to an exit temperature. The working total ratio is given by {(pipe cross-sectional area before working−pipe cross-sectional area after the last working)/pipe cross-sectional area before working}×100. The heat treatment after drawing was applied at 250° C. for 30 minutes. The elongation and the tensile strength were measured on all the resultant drawn pipe specimens. The exit temperature, total working ratio, use of heat treatment after drawing, elongation and tensile strength are shown in Table 20 for the respective specimens.

TABLE 20

| | | | Total | Heat | Elongation | |
|---|---|---|---|---|---|---|
| | | | working | treatment | after | Tensile |
| Specimen | Alloy | Exit temp. | ratio | after | fracture | strength |
| No. | type | (° C.) | (%) | drawing | (%) | (MPa) |
| 20-1 | ZK60 | 200 | 15 | No | 4 | 321 |
| 20-2 | ZK60 | 200 | 30 | No | 4 | 338 |
| 20-3 | ZK60 | 200 | 45 | No | 3 | 372 |
| 20-4 | ZK60 | 200 | 45 | Yes | 18 | 301 |

As is clear from Table 20, it turns out that the specimens subjected to heat treatment after drawing have a high elongation.

### EXPERIMENTAL EXAMPLE 3-4

In this experimental example, bending was applied using the same specimen No. 19-4 as fabricated in the experimental example 3-2. By a rotating bending method, bending was imparted to the drawn pipe specimen of 21.5 mm in outside diameter D and 1 mm in wall thickness at room temperatures to cause its bend of 2.8 D in radius of curvature. As a result, it was shown that the magnesium base alloy pipe prepared according to the present invention can be bent well in such a small bending radius.

### EXPERIMENTAL EXAMPLE 3-5

An extruded pipe of a ZK61 alloy was fabricated into a butted pipe in the following way. First, the starting extruded pipe of 28 mm in O.D. and 2.5 mm in wall thickness was drawn by plug drawing into a pipe of 24 mm in O.D. and 2.2 mm in wall thickness. Then, the drawn pipe was heat-treated at 250° C. for 30 minutes after drawing. For this drawing, pointing was done under the same conditions as for the specimen No. 18-3 in the experimental example 3-1 above, and drawing was under the same conditions as for the specimen No. 19-4 in the experimental example 3-2 above. This applies likewise in the plain drawing and the plug drawing to be described below.

Using the resultant drawn pipe, a butted pipe was fabricated by combining the plain drawing and the plug drawing, as illustrated in FIG. 6. First, one end of a drawn pipe 4 was passed through a die 3, and then the drawn pipe 4 was subjected to plain drawing without squeezing its wall between the plug 2 and the inside of the die 3 (FIG. 6A). Thereafter, the middle portion of the drawn pipe 4 was subjected to plug drawing, in which the drawn pipe 4 had its wall squeezed between the inside of the die 3 and the plug 2 reaching the inside of the die 3 (FIG. 6B). Then, the plug 2 was retracted, and the other end of the drawn pipe 4 was subjected also to plain drawing without squeezing the wall of the drawn pipe 4 between the plug 2 and the inside of the die 3 (FIG. 6A). By this process, a butted pipe 10 having thick-walled opposite end portions and a thin-walled intermediate portion could be formed, as shown in FIG. 7. The resultant butted pipe 10 was 23 mm in O.D., 2.3 mm in wall thickness at its opposite ends and 2.0 mm in wall thickness at its middle portion.

### EXPERIMENTAL EXAMPLE 4-1

Extruded pipes (O.D.: 26.0 mm, wall thickness: 1.5 mm, length: 2000 mm) of AM60, AZ31, AZ61 and ZK60 alloys were set as starting materials for the experiment. After being pointed for drawing, each pointed pipe was heat-treated at 350° C. for 1 hour to remove its work hardening or strain hardening due to pointing and then the pipe was subjected to drawing under the following conditions.

The drawing was performed in plug drawing method, and a high frequency heating unit provided just before the die was set up so that the temperature of the pipe just before it is inserted in the die was 150° C. The die had a 24.5 mm bore and the plug had a 21.7 mm O.D. For all the pipes, the area reduction ratio applied was 15.0%. In this experiment, the working turned out to be successful regardless of alloy types. It was shown that high-frequency heating is a very effective heating method.

### EXPERIMENTAL EXAMPLE 4-2

Extruded pipes (O.D.: 26.0 mm, wall thickness: 1.5 mm, length: 2000 mm) of AM60, Az31, AZ61 and ZK60 alloys were set as starting materials for the experiment. To point the pipe for drawing, its front end was heated by immersing it in a lubricant at 200° C. and then introduced into a swaging machine for pointing. This heating was effective for pointing the pipe without causing cracks or like defects. Sufficient heating was attained by 2 minutes, the immersion in lubricant turned out to be effective as a heating means. Besides, it was shown that according to the method of the present invention a magnesium base alloy pipe having a wall thickness of 0.5 mm may be produced.

### EXPERIMENTAL EXAMPLE 4-3

Twenty (20) extruded pipes (O.D.: 26.0 mm, wall thickness: 1.5 mm, length: 2000 mm) of an AZ61 alloy were set as starting materials for the experiment. After pointing the pipes for drawing, 10 extruded pipes were subjected to film coating at their initial working portions for drawing. The film coating was accomplished by first dispersing a PTFE resin in water to prepare its aqueous dispersion liquid, then immersing the pipes in this dispersion liquid only at their initial working portions and their peripheries, and subsequently heating the wet portions at 400° C. for about 5 minutes.

Then, the thus processed 10 pipes and remaining 10 unprocessed pipes were subjected to drawing. The drawing was performed in plug drawing method, and the pipes were heated by immersing them in a lubricant heated at 180° C. After taking out from the lubricant bath, the pipes were drawn on a drawing bench before they are naturally cooled. The temperature of the pipes just before entering the die was about 150° C. The die had a 24.5 mm bore and the plug had a 21.7 mm O.D. The area reduction ratio applied was 15.0%.

Seizing was observed in 6 out of 10 pipe specimens not subjected to film coating, while seizing was not observed at all in any of the coated pipe specimens. Thus, it turns out that even if limited to initial working portions and their peripheries the film coating is substantially effective for prevention of seizing.

### EXPERIMENTAL EXAMPLE 4-4

Twenty (20) extruded pipes (O.D.: 26.0 mm, wall thickness: 1.5 mm, length: 2000 mm) of an AZ61 alloy were set as starting materials for the experiment. After pointing, the extruded pipes were drawn once into pipes of 24.5 mm in. O.D. and 1.5 mm in wall thickness and then heat-treated at 350° C. for 1 hour.

The resultant primary-drawn pipes were pointed again for drawing and then further subjected to drawing in the following manner. The drawing was performed in plug drawing method. Among the total 20 pipe specimens, 10 specimens had their front end portions (initial working portions where the pipe walls first contact the die and the plug before the drawing starts) heated in an atmosphere heating furnace heated at 350° C. and were drawn on a drawing bench before they are naturally cooled to room temperatures. The temperature of the pipes just before entering the die was about 200° C. The remaining 10 pipe specimens were subjected to drawing without heating. That is, those remaining specimens were drawn without having their front end portions heated. The die had a 23.1 mm bore and the plug had a 20.4 mm O.D. The area reduction ratio applied was 14.9%.

Seizing was observed in 9 pipe specimens out of 10 specimens which were not heated at their front end portions, while no seizing was observed in those specimens heated at their front end portions. Thus, it turns out that even if limited to front end portions the heating is substantially effective for prevention of seizing.

Further, in a similar experiment where the heating temperature at the front end portion of the pipe was varied, no desirable effectiveness was observed at temperatures below 150° C., while the working was feasible but oxidation occurred at temperatures above 400° C.

### EXPERIMENTAL EXAMPLE 4-5

Extruded pipes (O.D.: 34.0 mm, wall thickness: 3.0 mm, length: 2000 mm) of an AZ61 alloy were set as a starting material for the experiment. After being pointed for drawing, each pointed pipe was heat-treated at 350° C. for 1 hour to remove its work hardening or strain hardening due to pointing and then the pipe was subjected to drawing under the following conditions. Ten such extruded pipes were drawn in plug drawing method, using a die having a 31 mm bore and a plug of O.D. 25 mm. The area reduction ratio was 9.7%. By immersing in a lubricant heated at 180° C., the pipes were heated before working so that their working temperature becomes 140° C. The working temperature here is the temperature of the pipes just before entering the die.

The resultant drawn pipes were heat-treated at 350° C. for 1 hour. The heat-treated drawn pipes were formed into butted pipes by using a mandrel under the following conditions. The thick-walled portions (O.D.: 30 mm) at the opposite ends of the pipes were worked using a mandrel of O.D. 24.2 mm, while their thin-walled portions were worked by using a mandrel locally having a larger outside diameter. For the mandrel drawing, the following conditions were selectively applied: (1) working temperature at room temperatures, and pipes coated with a fluororesin; (2) working temperature at room temperatures, and the mandrel coated with a fluororesin; (3) working temperature at room temperatures, without film coating; (4) working temperature at 140° C., pipes coated with a fluororesin; (5) working temperature at 140° C. the mandrel coated with a fluororesin; and (6) working temperature at 140° C., without film coating. For the fluororesin coating, a water-dispersible PFA was used. The experimental results are shown in Table 21.

TABLE 21

| | | | Working | | | | | | |
|---|---|---|---|---|---|---|---|---|---|
| | | | ratio at | Worked at room temperatures | | | Worked at 140° C. | | |
| | Die | Thin-walled | thin-walled | Fluororesin | Fluororesin | | Fluororesin | Fluororesin | |
| | I.D. | portion I.D. | portion | coated | coated | | coated | coated | |
| Pass | (mm) | (mm) | (%) | pipe | mandrel | Uncoated | pipe | mandrel | Uncoated |
| 1 | 29.0 | 23.2 | 9.9 | ◯ | ◯ | ◯ | ◯ | ◯ | ◯ |
| 2 | 29.0 | 23.5 | 14.1 | ◯ | ◯ | ◯ | ◯ | ◯ | ◯ |
| 3 | 29.0 | 23.8 | 18.3 | ◯ | ◯ | ◯ | ◯ | ◯ | ◯ |
| 4 | 29.0 | 24.0 | 21.1 | ◯ | ◯ | X | ◯ | ◯ | ◯ |
| 5 | 29.0 | 24.5 | 28.3 | X | X | X | ◯ | ◯ | ◯ |

As is clear from Table 21, a magnesium base alloy pipe may be worked into a butted pipe by using a mandrel, and such a butted pipe can be given a larger difference in its wall thickness by coating the pipe or mandrel with a fluororesin. Further, it is possible to fabricate a butted pipe with a further larger difference in its wall thickness by increasing the working temperature.

A working temperature below 100° C. did not yield any appreciable effectiveness, while the specimens underwent breakage when the working temperature applied was above 350° C. This is due to a reduced material strength.

Further, mandrel drawing was executed by using a mandrel of O.D. 22.0 mm for thick-walled portions of the pipe and a mandrel of O.D. 24.5 mm for the thin-walled portion. The drawing was done at room temperatures by coating the mandrels with a fluororesin. Further, for the drawing, 3 dies of I.D. 29.6 mm, 28.7 mm and 28.0 mm were used in the cited sequence in 3 passes, respectively, while applying annealing at about 350° C. after each drawing pass. Consequently, a butted pipe could be fabricated as having a large difference in wall thickness, with a 3.0 mm thickness at its thick-walled portions and a 1.75 mm thickness at its thin-walled portion.

### INDUSTRIAL APPLICABILITY

As fully described hereinbefore, the magnesium base alloy pipe manufactured by the method according to the present invention can combine high strength and toughness in balance by using specified pointing conditions and/or drawing conditions. Especially, this pipe is improved in properties including high tensile strength, high YP ratio or high 0.2% proof stress in addition to a high elongation after fracture representing its toughness. Accordingly, the magnesium base alloy pipe of the present invention are used effectively for applications requiring a light weight in addition to strength, including pipes for chairs, tables, wheelchairs, stretchers, pickels, or pipes for automobile frames or like frames.

1. A magnesium base alloy pipe, wherein said pipe is produced by drawing a pipe blank of a magnesium base alloy containing either of the following ingredients (1) or (2):
(1) about 0.1-12.0 mass % of Al; or
(2) about 1.0-10.0 mass % of Zn and about 0.1-2.0 mass % of Zr.

2. A magnesium base alloy pipe according to claim 1 above, wherein said pipe has a 3% or higher elongation and 250 MPa or higher tensile strength above.

3. A magnesium base alloy pipe according to claim 2 above, wherein said tensile strength is 350 MPa or above.

4. A magnesium base alloy pipe according to claim 2 above, wherein said elongation is in the range of 15-20% and said tensile strength is in the range of 250-350 MPa.

5. A magnesium base alloy pipe according to claim 2 above, wherein said elongation is 5% or above and said tensile strength is 280 MPa or above.

6. A magnesium base alloy pipe according to claim 5 above, wherein said tensile strength is above 300 MPa.

7. A magnesium base alloy pipe according to claim 5 above, wherein said elongation is 5% or above but below 12%.

8. A magnesium base alloy pipe according to claim 5 above, wherein said elongation is 12% or above.

9. A magnesium base alloy pipe, wherein said alloy contains either of the following ingredients (1) or (2) and said pipe has a 0.75 or greater YP ratio:
(1) about 0.1-12.0 mass % of Al; or
(2) about 1.0-10.0 mass % of Zn and about 0.1-2.0 mass % of Zr.

10. A magnesium base alloy pipe according to claim 9 above, wherein said YP ratio is 0.75 or above but below-0.90.

11. A magnesium base alloy pipe according to claim 9 above, wherein said YP ratio is 0.90 or above.

12. A magnesium base alloy pipe, wherein said alloy contains either of the following ingredients (1) or (2) and said pipe has a 0.2% proof stress of 220 MPa or above:
(1) about 0.1-12.0 mass % of Al; or
(2) about 1.0-10.0 mass % of Zn and about 0.1-2.0 mass % of Zr.

13. A magnesium base alloy pipe according to claim 12 above, wherein said 0.2% proof stress is 250 MPa or above.

14. A magnesium base alloy pipe, wherein said alloy contains either of the following ingredients (1) or (2) and said alloy has a 10 μm or smaller average grain size:
(1) about 0.1-12.0 mass % of Al; or
(2) about 1.0-10.0 mass % of Zn and about 0.1-2.0 mass % of Zr.

15. A magnesium base alloy pipe, wherein said alloy contains either of the following ingredients (1) or (2) and said alloy has a duplex grain structure comprising fine grains and coarse grains.
(1) about 0.1-12.0 mass % of Al; or
(2) about 1.0-10.0 mass % of Zn and about 0.1-2.0 mass % of Zr.

16. A magnesium base alloy pipe according to claim 15 above, wherein said alloy has a duplex grain structure comprising grains having a 3 μm or smaller average grain size and grains having a 15 μm or greater average grain size.

17. A magnesium base alloy pipe according to claim 16 above, wherein said grains having a 3 μm smaller average grain size have a 10% or greater grains area share.

18. A magnesium base alloy pipe, wherein said alloy contains either of the following ingredients (1) or (2) and said alloy has a mixed structure comprising twins and recrystallized grains.
(1) about 0.1-12.0 mass % of Al; or
(2) about 1.0-10.0 mass % of Zn and about 0.1-2.0 mass % of Zr.

19. A magnesium base alloy pipe according to any one of the preceding claim 1 through 18, wherein said pipe has a surface roughness Rz defined by Rz≦5 μm on the surface thereof.

20. A magnesium base alloy pipe according to any one of the preceding claim 1 through 18, wherein said pipe has a 80 MPa or smaller axial residual tensile stress in the surface thereof.

21. A magnesium base alloy pipe according to any one of the preceding claim 1 through 18, wherein said pipe has a 0.02 mm or smaller differential outside diameter.

22. A magnesium base alloy pipe according to any one of the preceding claim 1 through 18, wherein said pipe has a noncircular cross-sectional shape.

23. A magnesium base alloy pipe according to any one of the preceding claim 1 through 18, wherein said alloy comprises containing about 0.1-12.0 mass % of Al plus about 0.1-2.0 mass % of Mn.

24. A magnesium base alloy pipe according to claim 23 above, wherein said alloy comprises containing about 0.1-12.0 mass % of Al plus at least one ingredient to be selected from the group consisting of about 0.1-5.0 mass % of Zn and about 0.1-5.0 mass % of Si.

25. A magnesium base alloy pipe according to any one of the preceding claim 1 through 18, wherein said pipe have a 0.5 mm or smaller wall thickness.

26. A magnesium base alloy pipe according to any one of the preceding claim 1 through 18, wherein said pipe comprise a butted pipe having longitudinally a uniform outside diameter with its inside diameters at its opposite end portions being smaller than that of its intermediate portion.

27. A method of manufacturing a magnesium base alloy pipe comprising:
a step of providing a pipe blank of any one of the following magnesium base alloys (A) through (C):
(A) a magnesium base alloy containing about 0.1-12.0 mass % of Al;
(B) a magnesium base alloy containing about 0.1-12.0 mass % of Al plus at least one ingredient to be selected from the group consisting of about 0.1-2.0 mass % of Mn, 0.1-5.0 mass % of Zn and 0.1-5.0 mass % of Si; or
(C) a magnesium base alloy containing about 1.0-10.0 mass % of Zn and 0.1-2.0 mass % of Zr;
a metal pointing step for pointing said pipe blank; and
a drawing step for drawing the resultant pointed pipe blank;
wherein said drawing step is executed at a drawing temperature of 50° C. or above.

28. A method of manufacturing a magnesium base alloy pipe according to claim 27 above, wherein heating to said drawing temperature is accomplished by heating the pipe blank in an atmosphere furnace, heating the same in a high-frequency heating furnace, or heating a drawing die.

29. A method of manufacturing a magnesium base alloy pipe according to claim 27 above, wherein said drawing temperature ranges from 100° C. to 350° C.

30. A method of manufacturing a magnesium base alloy pipe according to claim 27 above, wherein area reduction ratio in one drawing pass is 5% or above.

31. A method of manufacturing a magnesium base alloy pipe according to claim 27 above, wherein said drawing step is accomplished in a multistep process using plurality of dies.

32. A method of manufacturing a magnesium base alloy pipe according to claim 27 above, wherein said drawing step is accomplished by using at least a die, heating only an initial working portion of a pointed pipe blank where it contacts said die, and drawing said pointed pipe blank at the temperature of the thus heated initial working portion or as it cools naturally therefrom.

33. A method of manufacturing a magnesium base alloy pipe according to claim 32 above, wherein a heating temperature of said initial working portion ranges of 150° C. or more but below 400° C.

34. A method of manufacturing a magnesium base alloy pipe comprising:
a step of providing a pipe blank of any one of the following magnesium base alloys (A) through (C):
(A) a magnesium base alloy containing about 0.1-12.0 mass % of Al;
(B) a magnesium base alloy containing about 0.1-12.0 mass % of Al plus at least one ingredient to be selected from the group consisting of about 0.1-2.0 mass % of Mn, 0.1-5.0 mass % of Zn and 0.1-5.0 mass % of Si; or
(C) a magnesium base alloy containing about 1.0-10.0 mass % of Zn and 0.1-2.0 mass % of Zr;
a metal pointing step for pointing said pipe blank; and
a drawing step for drawing the resultant pointed pipe blank;
wherein said pointing step is accomplished by heating at least a front working end of the pipe blank entering a pointing machine.

35. A method of manufacturing a magnesium base alloy pipe according to claim 34 above, wherein said front working end is heated at its portion contacting said pointing machine.

36. A method of manufacturing a magnesium base alloy pipe according to claim 34 above, wherein said pointing step is executed by controlling at least the temperature of said front working end entering said pointing machine to 50-450° C.

37. A method of manufacturing a magnesium base alloy pipe according to claim 34 above, wherein said pointing step is executed with a heat insulating material inserted in the front end of the pipe blank.

38. A method of manufacturing a magnesium base alloy pipe according to claim 34 above, wherein said pointing step is executed on a swaging machine by heating the front end of the pipe blank in a heated liquid.

39. A method of manufacturing a magnesium base alloy pipe according to claim 27 above, further comprising a lubrication step for lubricating at least an initial working portion of the pipe blank in advance of said drawing step.

40. A method of manufacturing a magnesium base alloy pipe according to claim 39 above, wherein said lubrication step comprises immersing the pipe blank in a preheated lubricant.

41. A method of manufacturing a magnesium base alloy pipe according to claim 39 above, wherein said lubrication step forms a lubricant coating on the pipe blank.

42. A method of manufacturing a magnesium base alloy pipe according to claim 41 above, wherein said lubricant coating comprises a fluorine-based resin.

43. A method of manufacturing a magnesium base alloy pipe according to claim 42 above, wherein said fluorine-based resin comprises a PTFE or PFA.

44. A method of manufacturing a magnesium base alloy pipe according to claim 41 above, wherein said lubricant coating is formed by dispersing a fluorine-based resin in water to prepare an aqueous dispersion thereof, immersing the pipe blank in said aqueous dispersion, and heating the pipe blank taken out of said aqueous dispersion.

45. A method of manufacturing a magnesium base alloy pipe according to claim 44 above, wherein the pipe blank taken out of said aqueous dispersion at about 300-450° C.

46. A method of manufacturing a magnesium base alloy pipe according to claim 27 above, wherein said drawing step comprises mandrel drawing using a mandrel passing through a die and a lubricant coating is formed on said mandrel.

47. A method of manufacturing a magnesium base alloy pipe according to claim 27 above, wherein said drawing step comprises:
a first plain drawing step in which one end of the pipe blank is passed through a die inside and the pipe blank is drawn without squeezing its wall between the inside of the die and a plug;
a plug drawing step for squeezing an intermediate portion of the pipe blank between the inside of the die and the plug; and
a second plain drawing step in which the other end of the pipe blank is drawn without squeezing its wall between the inside of the die and the plug;
to form a butted pipe having thick-walled opposite ends and a thin-walled intermediate portion.

48. method of manufacturing a magnesium base alloy pipe according to claim 27 above, wherein said drawing step comprises mandrel drawing using a mandrel having longitudinally varied outside diameters to form a butted pipe.

49. A method of manufacturing a magnesium base alloy pipe according to claim 48 above, wherein the pipe blank is drawn by grasping its front working end extending out of a die exit.

50. A method of manufacturing a magnesium base alloy pipe according to claim 48 above, wherein said drawing step is executed in multiple passes by using dies having varied inside diameters.

51. A method of manufacturing a magnesium base alloy pipe according to claim 27 above, further comprising a heat treatment step for heating a drawn pipe at 150° C. or higher temperatures.

52. A method of manufacturing a magnesium base alloy pipe according to claim 51 above, wherein said heat treatment step is executed at 300° C. or lower temperatures.
